(19) United States
(12) Patent Application Publication
(10) Pub. No.: US 2025/0390494 A1
(43) Pub. Date: Dec. 25, 2025

(54) DATA PROCESSING METHOD AND RELATED DEVICE

(71) Applicant: Tencent Technology (Shenzhen) Company Limited, Shenzhen (CN)

(72) Inventors: Qiangsheng Ye, Shenzhen (CN); Jie Jiang, Shenzhen (CN); Yuhong Liu, Shenzhen (CN); Peng Chen, Shenzhen (CN); Tun Tang, Shenzhen (CN); Wenwei Xue, Shenzhen (CN); Ruochen Zou, Shenzhen (CN); Zhaoming Xue, Shenzhen (CN); Guangxu Cheng, Shenzhen (CN)

(73) Assignee: Tencent Technology (Shenzhen) Company Limited, Shenzhen (CN)

(21) Appl. No.: 19/304,674

(22) Filed: Aug. 20, 2025

Related U.S. Application Data
(63) Continuation of application No. PCT/CN2024/101261, filed on Jun. 25, 2024.

(30) Foreign Application Priority Data
Aug. 24, 2023 (CN) 202311069542.X

(51) Int. Cl. G06F 16/2453; G06F 16/22; G06F 16/25

(52) U.S. Cl. CPC G06F 16/24542; G06F 16/2282; G06F 16/258

(57) ABSTRACT

A data processing method includes, obtaining metadata for a heterogeneous database including a first database and a second database, wherein the metadata maps an association relationship between a first data table of the first database and a second data table of the second database; updating the second data table by storing, in a cross-source operation, data from the first data table in the second data table based on the association relationship; receiving a query statement indicating the first data table; and executing the query statement on the updated second data table to obtain a query result indicating at least one piece of the data from the first data table.

### CROSS-REFERENCE TO RELATED APPLICATIONS

This application is a continuation application of International Application No. PCT/CN2024/101261 filed on Jun. 25, 2024, which claims priority to Chinese Patent Application No. 202311069542.X filed with the China National Intellectual Property Administration on Aug. 24, 2023, the disclosures of each being incorporated by reference herein in their entireties.

### FIELD

The disclosure relates to the field of computer technologies, and to a data processing method and a related device.

### BACKGROUND

With the development of big data technologies, more services depend on database systems. In the field of big data, many various data (or warehouse) base systems exist to deal with various types of big data services. In an actual service, a plurality of database systems may be selected to satisfy requirements for different scenarios. To resolve problems such as an isolated data island, a unified query may be performed using federated query/cross-source query. A materialized view of a database system may be created by using a specified structured query language (SQL), or a dedicated query tool may be used, to implement cross-source queries. With such solutions, use thresholds are high, utilization rates are low, and supported scenarios are limited. As a result, such methods result in data cross-source query inefficiencies.

### SUMMARY

Embodiments of this application provide a data processing method and a related device that is capable of supporting queries for a diverse array of scenarios and that is capable of improving the efficiency of cross-source queries.

According to an aspect of the disclosure, a data processing method includes, obtaining metadata for a heterogeneous database including a first database and a second database, wherein the metadata maps an association relationship between a first data table of the first database and a second data table of the second database; updating the second data table by storing, in a cross-source operation, data from the first data table in the second data table based on the association relationship; receiving a query statement indicating the first data table; and executing the query statement on the updated second data table to obtain a query result indicating at least one piece of the data from the first data table.

According to an aspect of the disclosure, a data processing apparatus includes, at least one memory configured to store computer program code; and at least one processor configured to read the program code and operate as instructed by the program code, the program code including obtaining code configured to cause at least one of the at least one processor to obtain metadata for a heterogeneous database including a first database and a second database, wherein the metadata maps an association relationship between a first data table of the first database and a second data table of the second database; and updating code configured to cause at least one of the at least one processor to update the second data table by storing, in a cross-source operation, data from the first data table in the second data table based on the association relationship; and query code configured to cause at least one of the at least one processor to receive a query statement indicating the first data table; and execute the query statement on the updated second data table to obtain a query result indicating at least one piece of the data from the first data table.

According to an aspect of the disclosure, a non-transitory computer storage medium, storing computer code which, when executed by at least one processor, causes the at least one processor to at least obtain metadata for a heterogeneous database including a first database and a second database, wherein the metadata maps an association relationship between a first data table of the first database and a second data table of the second database; update the second data table by storing, in a cross-source operation, data from the first data table in the second data table based on the association relationship; receive a query statement indicating the first data table; and execute the query statement on the updated second data table to obtain a query result indicating at least one piece of the data from the first data table.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a diagram of an architecture of a data processing system according to some embodiments.

FIG. 2 is a schematic flowchart of a data processing method according to some embodiments.

FIG. 3 is a schematic diagram of a process of cross-source storage according to some embodiments.

FIG. 4 is a schematic flowchart of another data processing method according to some embodiments.

FIG. 5A is a schematic diagram of a data configuration interface according to some embodiments.

FIG. 5B is a schematic diagram of another data configuration interface according to some embodiments.

FIG. 5C is a schematic diagram of a configuration item and configuration information according to some embodiments.

FIG. 5D is a schematic diagram of an execution task according to some embodiments.

FIG. 6A is a schematic diagram of a statement execution task according to some embodiments.

FIG. 6B is a schematic diagram of a data heating task according to some embodiments.

FIG. 6C is a flowchart of adaptive data heating according to some embodiments.

FIG. 6D is a schematic diagram of a cold-and-hot data scenario according to some embodiments.

FIG. 7 is a flowchart of adaptive query acceleration according to some embodiments.

FIG. 8 is a schematic diagram of the structure of a data processing apparatus according to some embodiments.

FIG. 9 is a schematic diagram of the structure of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

As used herein, the term “unit [s]” may refer to hardware logic, a processor or processors executing computer software code, or a combination of both. The “units” may also be implemented in software stored in memory of a computer or a non-transitory computer-readable medium, where the instructions of each unit are executable by a processor to thereby cause the processor to perform the respective operations of the corresponding unit.

Each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the data processing apparatus may further include other units. In actual applications, these functions may also be realized cooperatively by the other units, and may be realized cooperatively by multiple units.

Some embodiments provide a data processing method. According to the data processing method, data tables in a heterogeneous database may be bound by using an association relationship mapped by metadata. Data in one database may accordingly be stored in another database in a cross-source manner based on the binding between the plurality of data tables in the heterogeneous database, so that query logic can be optimized based on a cross-source storage result, and data can be queried from the other database through optimization of the query logic. When data from different data sources is queried, the data from the different data sources may be queried based on one database, for example, a uniform cross-source query may be implemented, thereby improving the efficiency of the cross-source query. When data in the data source (which corresponds to a first database) and that is stored in the cross-source manner is queried, the query may also be performed in the data source (which corresponds to a second database) that receives the cross-source storage, to obtain the requested data. In some scenarios, the speed of the query may be improved, and query validity may be ensured. One database serves as one data source, and the cross-source storage of the data may be understood as cross-source storage of the data, for example, data in one database is stored in another database.

The metadata mentioned above is data configured for describing a data entity, and may be understood as descriptive information of data and an information resource. For example, in a database system, metadata of a data entity is, for example, the name of a data table, a field name, a field property, and an index. The complete data entity may be described by using definitions of the metadata. The metadata may be configured for mapping an association relationship between different data tables distributed in the heterogeneous database. For example, the metadata may be configured for mapping an association relationship between a data table al in a database A and a data table bl in a database B.

The heterogeneous database refers to a plurality of (at least two, for example) databases. The database may also be referred to as a data warehouse, a database system, or a data warehouse system. The heterogeneous database may also be referred to as a heterogeneous data warehouse or a heterogeneous data (warehouse) base system. The heterogeneous database system refers to a set including database systems of different types or different architectures, or database systems developed by different manufacturers. These database systems may use different data models, query languages, storage methods, and the like. A plurality of different types of databases can be managed and accessed in a unified environment by using the heterogeneous database system, to provide a more flexible and comprehensive data management capability.

The association relationship that is between the first data table and the second data table and that is mapped by the metadata may include at least one of a cold-and-hot relationship, a union relationship, a primary-and-secondary relationship, a materialized-view relationship, and the like. The association relationship between the plurality of tables is mapped by the metadata, so that the data tables in the heterogeneous database can be bound together. The diversified association relationships can enable binding between the plurality of data tables distributed in the heterogeneous database to be more flexible, and can deal with data processing for various scenarios. Data heating, cooling, backup, pre-computation, and the like may be adaptively performed based on definitions of the association relationships between the plurality of tables. A scheduling rule may be automatically determined for task scheduling, to implement data processing.

Based on the foregoing association relationship, scenarios to which the data processing method may be applied include, but are not limited to: cold-and-hot data, data union (UNION), data backup, and a materialized view. Using the cold-and-hot data scenario as an example, cold-and-hot data is configured, so that subsequently, a computing engine can adaptively perform processing based on a storage relationship between cold data and hot data. When queried data relates to data in a hot table, queries may be optimized by using the hot table to implement queries quickly. In the data backup scenario, the data backup may be configured, so that data query is performed, in a case in which a database fails and cannot be queried, based on backup data backed up to another database. Query validity may therefore be ensured. In the data union scenario, the plurality of tables of the heterogeneous database may be associated by using the configured metadata, so that more comprehensive data can be rapidly found by accessing one database. In the materialized-view scenario, a materialized view may be defined using the metadata, so that use thresholds of the materialized view may be lowered, and so that queries can be quickly implemented based on the materialized view.

Based on the foregoing definitions, a data processing method is described below. Metadata configured for a heterogeneous database may be obtained, the heterogeneous database including a first database and a second database, the metadata being configured for mapping an association relationship between a first data table and a second data table, the first data table being located in the first database, and the second data table being located in the second database. The association relationship that is between the plurality of tables and that is mapped by the metadata is, for example, a cold-and-hot relationship, a primary-and-secondary relationship, and a materialized-view relationship. At least one piece of data in the first data table in the first database may be stored in the second data table in the second database in a cross-source manner based on the association relationship mapped by the metadata, to update the second data table. Data from different data sources may be merged into one database through cross-source storage, to further provide a data cross-source query service by using a query engine based on an updated second data table in the second database.

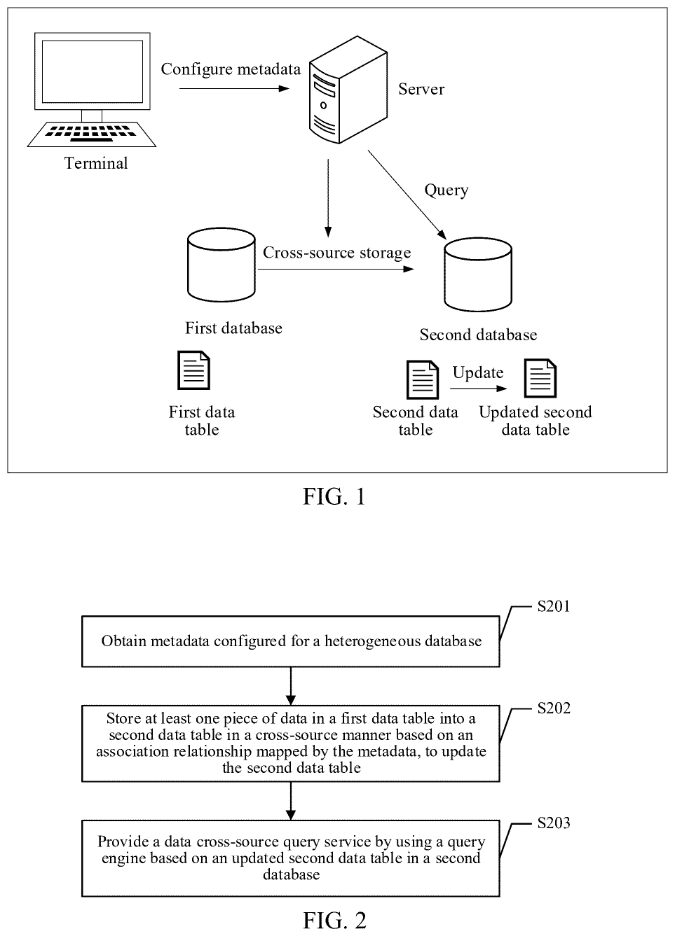

In some embodiments, the foregoing method may be performed by a computer device, and the computer device may be a terminal or a server. For example, the server may obtain the metadata configured for the heterogeneous database, store the at least one piece of data in the first data table in the first database into the second data table in the second database in the cross-source manner based on the association relationship mapped by the metadata, and provide the cross-source query service by using the query engine based on the updated second data table. The foregoing method may be performed by a terminal and a server together. For example, as shown in FIG. 1, the terminal may configure the metadata for the heterogeneous database, and the terminal obtains the metadata configured for the heterogeneous database and sends the metadata to the server. The server may store the at least one piece of data in the first data table in the first database into the second data table in the second database in the cross-source manner based on the association relationship mapped by the metadata, and provide the cross-source query service by using the query engine based on the updated second data table.

The foregoing terminal includes, but is not limited to, a smartphone, a tablet computer, an intelligent wearable device, an intelligent voice interaction device, an intelligent appliance, a personal computer, a vehicle-mounted terminal, an intelligent camera, a virtual reality device, and the like. This is not limited. The quantity of terminals is not limited. The server may be an independent physical server, a server cluster or distributed system including a plurality of physical servers, or a cloud server that provides a cloud computing service such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto. The quantity of servers is not limited.

The data processing method relates to cloud technologies, and to content in aspects such as databases and big data. A database may be thought of as an electronic file cabinet, which is a location for storing electronic files. A user may perform operations such as adding, query, updating, and deleting data in the files. The “database” is a data set that is stored together in a certain manner, can be shared with a plurality of users, minimizes redundancy, and is independent of an application program. Big data refers to a data set that cannot be captured, managed, and processed in a certain time range by using a conventional software tool, and is a massive and diversified information asset with a high growth rate, which requires a new processing mode to achieve a stronger decision-making capability, insight and discovery capability, and procedure optimization capability. With the advent of the cloud era, big data may attract more attention. Big data requires special technologies to effectively process a large amount of data within tolerable duration. The technologies applicable to the big data include a massively parallel processing database, data mining, a distributed file system, a distributed database, a cloud computing platform, the Internet, and an extensible storage system. The association relationship mapped by the metadata may bind data tables in different databases to implement cross-source query of data. The cross-source query refers to cross-database query, for example, data query performed in the different databases. Parallel processing on the plurality of databases and calculation on data may be involved when cross-source query of the data is performed.

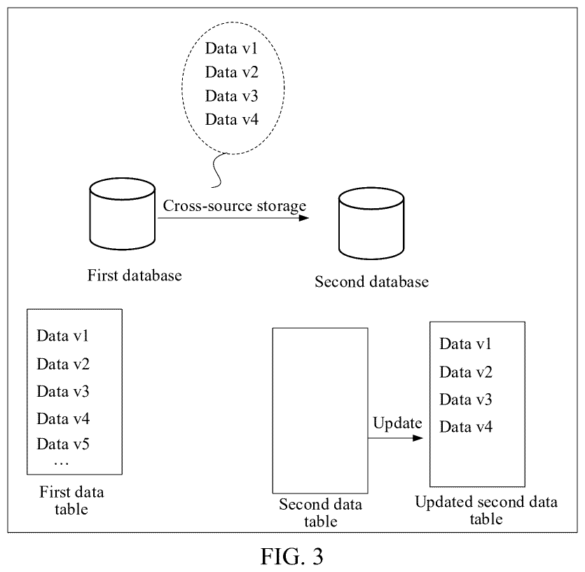

Based on the foregoing descriptions, some embodiments provide a data processing method. The data processing method may be performed by the foregoing computer device (the terminal or the server), or may be performed by a terminal and a server together. For ease of description, an example in which a computer device performs the data processing method is used subsequently for description. Referring to FIG. 2, the data processing method may include the following operations S201 to S203.

S201: Obtain metadata configured for a heterogeneous database.

The heterogeneous database includes a first database and a second database. The metadata is configured to map an association relationship between a first data table and a second data table. The first data table is located in the first database, and the second data table is located in the second database. The first database may include at least one data table, and the second database may also include at least one data table. The first data table and the second data table may be pre-stored in the corresponding databases, or may be data tables that are temporarily created based on creation indication information in the metadata and configured for storing data. For example, the first database is a Hive database, and the second database is a StarRocks database. The first data table is an existing data table in the Hive database and may be referred to as a Hive table. The second data table is an existing data table in the StarRocks database and may be referred to as a StarRocks table. The StarRocks database is a database configured for storing a StarRocks table, and the StarRocks table is a data table including rows and columns. The Hive database is a database configured for storing a Hive table, and the Hive table is a data table including table data and related data (configured for describing information such as a structure and an index of the table).

The metadata is data configured for describing a data entity. In some embodiments, the metadata may be configured for the heterogeneous database using a key-value pair configuration or a user interface (UI) configuration. The metadata obtained by the computer device may be information in the form of a key-value pair, and may be a key-value pair based on JavaScript Object Notation (JSON) or a language Yet Another Markup Language (YAML). JSON is a data interchange format, and the language YAML is a human-readable data serialization language. Because the metadata is the information in the form of the key-value pair, the association relationship between the plurality of data tables may accordingly not be mapped based on an SQL, but more logic between the plurality of data tables is mapped by using the metadata, so that a use threshold of a user can be lowered, and a more generalized function is provided to support data processing in a corresponding scenario.

In some embodiments, the metadata configured for the heterogeneous database may be a virtual table defined by a user, and content related to the virtual table may all be referred to as the metadata. For example, when a virtual table configured for mapping a cold-and-hot relationship between the plurality of tables is defined, the metadata includes, but is not limited to, a table type of the virtual table, a storage type of the virtual table, the name of a cold-and-hot table related to the virtual table, the name of a column corresponding to the cold-and-hot table, and the like. Based on a relationship between the metadata and the virtual table, the virtual table may be configured for mapping an association relationship between specified data tables in the heterogeneous database. The virtual table may provide a representation method for the metadata and may define the association relationship between the plurality of data tables. For example, the metadata may be defined as follows:

```
  DROP VTABLE IF EXISTS oms.test_cold_table_all_type_day;
  CREATE VTABLE IF NOT EXISTS oms.test_cold_table_all_type_day WITH (
  ‘tableType’=‘COLD_HOT’,——table type, cold-and-hot table
  ‘storageType’=‘PARTIAL_HOT’,——storage type, partial data heating
  ‘coldTable’=‘oms.test_cold_table_all_type_day’,——cold table, Hive table (data
warehouse)
  ‘coldTableColumns'=‘int_col, boolean_col, tinyint_col, smallint_col, largeint_col,
float_col, double_col, decimal_col, char_col, varchar_col, bigint_col’,——Name of a column to
be cropped/mapped in the cold table
  ‘partitionColumn’=‘bigint_col’,——partition column of the Hive table
  ‘partitionDateTimeFormat’=‘yyyyMMdd’,——partition format of the Hive table
  ‘hotTable’=‘starrocks_teg_test_gz_root.test_cold_table_all_type_day’,——hot
table, starRocks table (data warehouse)
  ‘hotTableColumns'=‘int_col, boolean_col, tinyint_col, smallint_col, largeint_col,
float_col, double_col, decimal_col, char_col, varchar_col, bigint_col’,——Name of a column
corresponding to the cold table in the hot table
  ‘startPartition’=‘20230401’,——start partition in the hot table
  ‘delayTime'=‘7200’,——delay
  ‘hotPartitioncount’=‘30’——Quantity of hot partitions stored in the hot table
  );
```

The metadata is a virtual table defined by a user, and includes a definition of a key-value pair. For example, in the configuration of ‘tableType’=‘COLD_HOT’, the table type (tableType) corresponds to a key, and the cold-and-hot table (COLD_HOT) corresponds to a value. These key-value pairs may be based on JSON parameters when the virtual table is defined. A cold-and-hot relationship between two data tables is mapped by the virtual table oms.test_cold_table_all_type_day. The two data tables are respectively a data table having a table name oms.test_cold_table_all_type_day in the Hive database, and a data table having a table name starrocks_teg_test_gz_root.test_hot_table_all_type_day in the StarRocks database. The metadata further indicates heat data after 20230401 (startPartition, the start partition), and the quantity of hot partitions (hotPartitioncount) is 30. Based on the configuration of the foregoing metadata, the virtual table is a data table storing data in partitions by using a day as a unit, and may include heated data in last 30 days.

Data of the oms database is stored in Hive, and data of the database starrocks_teg_test_gz_root is stored in a StarRocks engine. For ease of uniform management, the name of the virtual table is the same as the name of the cold table. Assigning names in this manner may limit permission of a user for the virtual table by using permission of the user for the cold table. The association relationship between the data tables in the heterogeneous database may be mapped by using the virtual table, thereby implementing binding between the plurality of tables. For example, the cold-and-hot relationship may be mapped between the tables of the two database systems, for example, the Hive and the StarRocks, by using the foregoing example virtual table, to further implement binding between the Hive table and the StarRocks table.

In some embodiments, the virtual table may be a real table, table properties such as a schema (a set of database objects such as a field and a view), a primary key, and an index may be defined by using a data definition language (DDL), and an underlying system may perform optimization such as adaptive cold/hot, storage and computing, and read/write in the underlying system based on the definition of the virtual table. An underlying data (warehouse) base system may be compatible with the virtual table to implement a corresponding function.

A relationship between data tables under different association relationships may include the following content: (1) a cold-and-hot relationship between two (or more) tables of two different data (warehouse) base systems is mapped, where one table is configured for storing hot data of the other table. In some embodiments, the cold-and-hot relationship is configured for indicating that the first data table serves as a cold table to store full data in the first database, and the second data table serves as a hot table to store partial data in the first data table. The data stored in the first data table may be referred to as cold data, and the data stored in the second data table may be referred to as hot data. The cold table refers to a table storing the cold data, and the cold data refers to data that is rarely accessed (for example, data whose access frequency is less than a preset threshold). Correspondingly, the hot table refers to a table storing the hot data, and the hot data refers to data that is frequently accessed (for example, data whose access frequency is greater than the preset threshold). (2) A union relationship (which is also referred to as a combination relationship) between two (or more) tables of two different data (warehouse) base systems is mapped, where the two tables unite into full data. In some embodiments, the union relationship is configured for indicating that the first data table and the second data table unite to form full data in the first database. (3) A primary-and-secondary relationship between two (or more) tables of two different data (warehouse) base systems is mapped, where one table is configured for storing backup data of the other table. In some embodiments, the primary-and-secondary relationship is configured for indicating that the first data table serves as a primary table to store full data in the first database, and the second data table serves as a secondary table to back up the data in the first data table. (4) A materialized-view relationship between a plurality of tables of two different data (warehouse) base systems is mapped, where one table is result data obtained by performing pre-calculation on a plurality of other tables. In some embodiments, the materialized-view relationship is configured for indicating that the second data table is configured for storing result data obtained by performing pre-calculation on the first data table. The second data table may be configured for storing result data obtained by performing pre-calculation on the first data table and another data table in the first database.

S202: Store at least one piece of data in the first data table into the second data table in a cross-source manner based on the association relationship mapped by the metadata, to update the second data table.

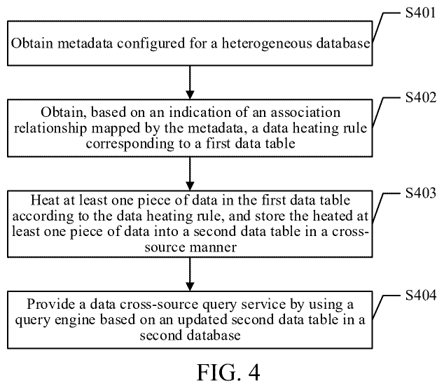

In some embodiments, the at least one piece of data that is stored in the cross-source manner in the first data table may be first determined based on the association relationship, and the determined at least one piece of data is stored in the second data table in the second database in the cross-source manner. The data may accordingly be newly added to the second data table, to obtain an updated second data table. In some embodiments, if the second data table is an empty data table, the updated second data table includes the at least one piece of data that is stored in the cross-source manner in the first data table. For example, FIG. 3 is a schematic diagram of a process of cross-source storage. A plurality of pieces of data (including data v1 to v4) in a data table al of a database A are stored in a database B in the cross-source manner, and a data table b1 in the database B includes the data v1 to v4. In some embodiments, if the second data table originally includes original data in the second database, the updated second data table includes the original data in the second database and the newly stored at least one piece of data in the first data table. The second data table in the second database may be updated through cross-source storage, and the updated second data table includes at least data of another data source (for example, the first database), so that data support is provided for cross-source query.

S203: Provide a data cross-source query service by using a query engine based on an updated second data table in the second database.

The query engine is an engine configured for performing data query processing and having a computing function. According to a deployment feature, the query engine may be a distributed query engine or a centrally deployed query engine. According to a working characteristic, the query engine may be a SuperSQL (internal uniform query engine) or another engine, for example, an engine supported based on a framework such as Apache Calcite, Spark, Presto, or Doris.

In some embodiments, the computer device may invoke the query engine based on a received query instruction, to perform data cross-source query. The query instruction may be a query statement (for example, an SQL statement) obtained by using the query engine, or a query instruction initiated based on a visual query interface. Data that the query instruction instructs to query relates to the data in the first database, and relates to the data stored in the cross-source manner in the first data table. The computer device may accordingly optimize query logic, so that only the second database is accessed during an actual query, and the requested data is found from the updated second data table. The query logic may also be optimized, so that the query engine can find, from only the second database, the data that is from the first database, to implement cross-source query.

In an implementable manner, the computer device may preset a query optimization configuration item, and the query optimization configuration item is configured for indicating whether to enable a query optimization function. For example, setting of the query optimization configuration item is setting of a Set parameter below: Set ‘supersql.vtable.optinize.enabled’=true. The setting of the Set parameter indicates to enable a query optimization function in the SuperSQL engine. When it indicates to enable the query optimization function, the query logic may be optimized in a query process. The optimization of the query logic may enable the computer device to provide the data cross-source query service by using the query engine based on the updated second data table in the second database. For example, in a cold-and-hot data scenario, the query optimization function may be enabled based on the setting of the Set parameter. When scanned data is within a range of the hot data in the hot table during data query, optimization may be adaptively performed to query the data in the hot table. Because the hot table is stored in a database having a better hardware capability and a faster calculation speed, a query speed can be significantly improved. The data processing method may be integrated into various database products. An integration effect may be evaluated based on a cross-source capability of the engine, and can be implemented only by modifying logic of an SQL layer and the bound metadata. Diversified query scenarios can accordingly be dealt with, and valid query in the corresponding scenarios or increasing of the query speed is implemented.

According to the data processing method, the association relationship between the plurality of data tables may be mapped by the metadata, thereby implementing binding between the data tables of the heterogeneous database, and providing an optimization basis for data cross-source query. A part or all of the data in the first data table included in the first database is stored in the second data table in the second database in the cross-source manner based on the association relationship mapped by the metadata, so that the second database has data of another data source. When the data in the first data table and the second data table (for example, data distributed in the heterogeneous database) are queried in the cross-source manner, the requested data can be found by only by accessing the second database, and the efficiency of the cross-source query may accordingly be improved. If the data queried relates to the data in the first data table, data query can also be implemented by accessing the second data table in the second database based on cross-source storage of the data in the first data table, so that a requirement in a corresponding query scenario is satisfied. In this solution, heterogeneous storage is performed by fusing the query engine and mapping by the metadata. For example, in the cold-and-hot data scenario, adaptive query acceleration can be performed based on a storage relationship between cold data and hot data. Because configuration of the metadata is simple, and secondary development is not required, a utilization rate is high, and there are many applicable scenarios.

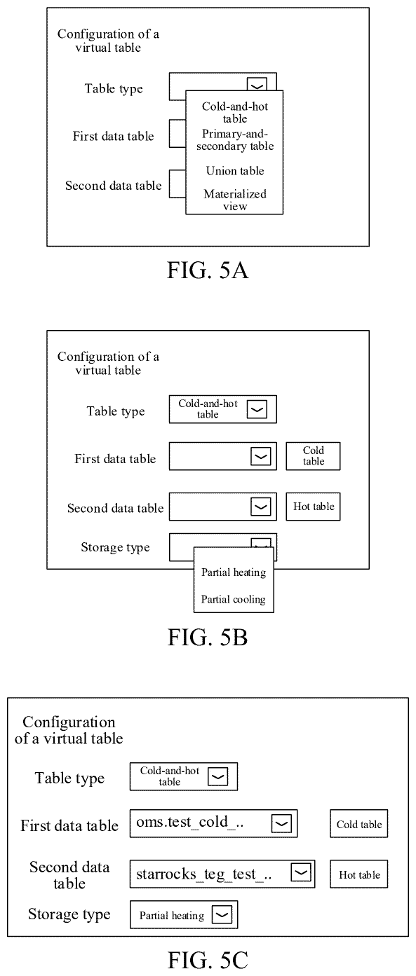

Based on the method shown in FIG. 2, some embodiments provide a more data processing method. In some embodiments, an example in which a computer device performs the data processing method is used for description. Referring to FIG. 4, the data processing method may include the following operations S401 to S404.

S401: Obtain metadata configured for a heterogeneous database.

The heterogeneous database includes a first database and a second database. The metadata is configured to map an association relationship between a first data table and a second data table. The first data table is located in the first database, and the second data table is located in the second database. In some embodiments, when obtaining the metadata configured for the heterogeneous database, the computer device may perform content shown in the following (1) and (2).

(1) Obtain a plurality of key-value pairs configured by a target object for the heterogeneous database.

The target object may be any user that configures the key-value pairs for the heterogeneous database by using a query engine. The plurality of key-value pairs configured for the heterogeneous database refers to two or more key-value pairs (Key-Value). The plurality of key-value pairs include at least a key-value pair configured for indicating the first data table, a key-value pair configured for indicating the second data table, and a key-value pair configured for indicating the association relationship between the first data table and the second data table.

In some embodiments, a key included in the key-value pair configured for indicating the first data table (or the second data table) may be configured for describing a property of the first data table (or the second data table) in the association relationship, and a value may be an identifier of the first data table (or the second data table). For example, the key-value pair configured for indicating the first data table may be as follows: ‘coldTable’=‘oms.test_cold_table_all_type_day’. coldTable is configured for indicating that the first data table serves as a cold table.oms.test_cold_table_all_type_day is the identifier of the first data table. It can be learned, based on the identifier, that the first data table is a data table in an oms database and a table name used in the oms database. The key-value pair configured for indicating the second data table may be as follows:

‘hotTable’=‘starrocks_teg_test_gz_root.test_cold_table_all_type_day’. hotTable is configured for indicating that the second data table serves as a hot table. The identifier of the second data table is starrocks_teg_test_gz_root.test_cold_table_all_type_day. It can be learned, based on the identifier, that the second data table is a data table in a StarRocks database and a table name used in the StarRocks database.

The key-value pair configured for indicating the association relationship between the first data table and the second data table may include at least one of the following: a key-value pair configured for defining a table type of a virtual table, a key-value pair configured for indicating a correspondence between columns of the two data tables, and the like. For example, the key-value pair configured for indicating the association relationship between the first data table and the second data table in the plurality of key-value pairs may include ‘tableType’=‘COLD_HOT’. tableType is configured for indicating a table type of a virtual table to be created. COLD_HOT represents a cold-and-hot table. It can be learned, based on the key-value pair, that the association relationship between the first data table and the second data table is a cold-and-hot relationship. There is a key-value pair configured for indicating another property of the first data table and another property of the second data table, for example, a key-value pair related to a partition format of the data table or the name of a column corresponding to the first data table in the second data table. In some embodiments, the configured plurality of key-value pairs may further include a key-value pair that may be further configured for indicating a configured data processing rule corresponding to the association relationship, so that data in the data table can be processed according to the data processing rule, to provide a data cross-source storage service. For example, the key-value pair includes a key-value pair configured for defining a storage type (for example, indicating that the storage type is partial heating), a key-value pair configured for indicating a range of data allowed to be stored in the first data table, and a key-value pair configured for indicating the amount of requested data in the second data table.

(2) Create a virtual table by using the plurality of key-value pairs, and use the created virtual table as the metadata configured for the heterogeneous database.

In some embodiments, the plurality of key-value pairs may be combined with a statement for creating a virtual table, to obtain virtual table creation information, to create the virtual table. The created virtual table may serve as the metadata configured for the heterogeneous database, to map the association relationship between the plurality of tables. For example, virtual table creation information shown below may be configured for creating a virtual table:

```
  DROP VTABLE IF EXISTS oms.test_cold_table_all_type_day,——determine
whether a virtual table oms.test_cold_table_all_type_day exists
  CREATE VTABLE IF NOT EXISTS oms.test_cold_table_all_type_dayWITH(
  ‘tableType’=‘COLD_HOT’,——table type, cold-and-hot table
  ‘storageType’=‘PARTIAL_HOT’,——storage type, partial data heating
  ‘coldTable’=‘oms.test_cold_table_all_type_day’,——cold table, Hive table (data
warehouse)
  ‘coldTableColumns'=‘int_col, boolean_col, tinyint_col, smallint_col, largeint_col,
float_col, double_col, decimal_col, char_col, varchar_col, bigint_col’,——Name of a column to
be cropped/mapped in the cold table
  ‘partitionColumn’=‘bigint_col’,——partition column of the Hive table
  ‘partitionDateTimeFormat’=‘yyyyMMdd’,——partition format of the Hive table
  ‘hotTable’=‘starrocks_teg_test_gz_root.test_cold_table_all_type_day’,——hot
table, starRocks table (data warehouse)
  ‘hotTableColumns'=‘int_col, boolean_col, tinyint_col, smallint_col, largeint_col,
float_col, double_col, decimal_col, char_col, varchar_col, bigint_col’,——Name of a column
corresponding to the cold table in the hot table
  ‘hotPartition’=‘20230501’, ‘20230503’#‘20230505’, ‘20230510’,——partitioned data
existing in the hot table
  ‘startPartition’=‘20230401’,——start partition in the hot table
  ‘hotPartitioncount’=‘50’——Quantity of hot partitions stored in the hot table
  );
```

The virtual table oms.test_cold_table_all_type_day is defined as above. The virtual table maps tables of two data warehouses, for example, Hive and StarRocks, into a cold-and-hot relationship. A Hive table serves as a cold table and includes full data. A StarRocks table serves as a hot table. A background thread of the computer device may automatically adapt to the cold table, and periodically heat partitioned data in the cold table into the hot table based on a configuration. Data in last 50 days may be heated, but the data in the last 50 days does not include data before the partition indicated by 20230401.

In a process of defining the metadata in the foregoing manner, the virtual table is created in the form of a key-value pair, to obtain the metadata configured for the heterogeneous database. The virtual table is created in the form of the key-value pair, so that a user does not need to learn a complex SQL rewriting rule and principle. Through this simple configuration, the association relationship between the plurality of tables can be properly set, to map the association relationship between the data tables distributed in the heterogeneous database. This is a simple manner, and can reduce the use threshold of the user, so that a utilization rate of mapping the relationship between the plurality of tables based on the virtual table can be improved, and a use scenario is extended.

In some embodiments, the target object may autonomously write the key-value pair by using the query engine, so that the computer device can obtain the key-value pair configured for the heterogeneous database. When obtaining the plurality of key-value pairs configured by the target object for the heterogeneous database, the computer device may provide, by using a user interface (UI), a function of configuring the key-value pairs. Content shown in the following (1.1) to (1.3) may be included, for example.

(1.1) Display a data configuration interface of the heterogeneous database.

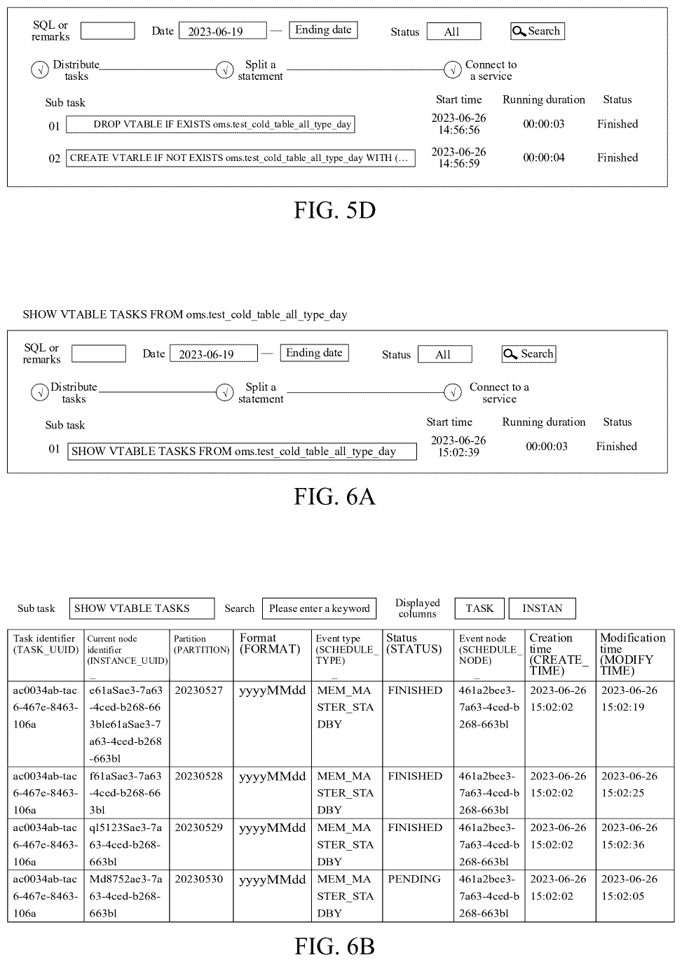

The data configuration interface is a configuration interface configured for providing the metadata for the heterogeneous database. The data configuration interface may include a plurality of configuration items, and data configuration may be performed based on the configuration items to obtain the key-value pairs for the heterogeneous database. In some embodiments, the data configuration interface includes at least the following configuration items: a configuration item configured for configuring the first data table, a configuration item configured for configuring the second data table, and a configuration item configured for configuring the association relationship between the first data table and the second data table. Each configuration item may be displayed on the data configuration interface by using a text, a pattern, or a combination thereof. For example, a data configuration interface shown in FIG. 5A includes three configuration items, which are respectively a configuration item configured for configuring a table type, a configuration item configured for configuring the first data table, and a configuration item configured for configuring the second data table. A plurality of types of configuration information may be provided under each configuration item for a user to select, so that a key-value pair may be generated based on the selected configuration information and configuration item. For example, a plurality of table types may be provided under the configuration item configured for configuring the table type. The computer device may select, based on a selection operation of the user, one of the plurality of table types as final configuration information of the configuration item, to represent configuring the association relationship between the first data table and the second data table.

In some embodiments, in addition to the foregoing configuration items, the data configuration interface may further include other configuration items. The configuration items may be added by the user in a customized manner, or automatically displayed on the data configuration interface based on setting of the configuration information of the existing configuration items. For example, as shown in FIG. 5B, after a cold-and-hot relationship is configured, a configuration item configured for configuring a storage type and a configuration item configured for configuring a hot data partition in the cold-and-hot relationship may be further displayed on the data configuration interface.

(1.2) Display, based on a configuration operation performed by the target object on each configuration item on the data configuration interface, configuration information of the corresponding configuration item.

The configuration operation performed by the target object on each configuration item on the data configuration interface may include a selection operation on the configuration information, an input operation on the configuration information, and the like. For example, after the item for configuring the table type shown in FIG. 5A is clicked, a plurality of pieces of configuration information for the configuration item may be displayed, and one of the plurality of pieces of configuration information is selected therefrom based on a selection operation as configuration information displayed on the data configuration interface. Based on the configuration items included in the data configuration interface, the configuration information herein may include configuration information of the configuration item configured for configuring the first data table, configuration information of the configuration item configured for configuring the second data table, and configuration information of the configuration item configured for configuring the association relationship between the first data table and the second data table. The foregoing configuration information may include a digit, a text, or a character. This is not limited. Each piece of configuration information matches a corresponding configuration item. For example, FIG. 5C shows the configuration information of each configuration item displayed on the data configuration interface.

(1.3) Perform, in response to a configuration ending operation, format conversion on the currently displayed configuration information of each configuration item based on data formats of the key-value pairs, to obtain the plurality of key-value pairs configured by the target object for the heterogeneous database.

The configuration ending operation may be a confirmation operation generated by triggering a confirmation control on the data configuration interface, or may be a confirmation operation generated by operating a physical key of the computer device. The configuration information of each configuration item may be determined based on the confirmation operation, so that the computer device can perform format conversion on the currently displayed configuration information of each configuration item based on the data formats of the key-value pairs. Each configuration item and the configuration information may be converted into a format of a key-value pair. One configuration item and configuration information of the configuration item may be converted into one key-value pair. For example, the configuration item “table type” and configuration information “cold-and-hot table” of the table type that are shown in FIG. 5C may be converted into a key-value pair ‘tableType’=‘COLD_HOT’ that is in a JSON format. Format conversion is performed on the displayed configuration information of each configuration item in the foregoing manner, so that the plurality of key-value pairs configured by the target object for the heterogeneous database can be obtained.

The foregoing manner of obtaining the key-value pairs shown in (1.1) to (1.3) is to provide the visual data configuration interface, and obtain the key-value pairs through format conversion after the user performs configuration on the data configuration interface in a customized manner. Based on the provisioning of the configuration items on the data configuration interface, the user can obtain the required configuration information only by performing filling or selection, and the computer device further automatically converts the required configuration information into the required key-value pairs. The user does not need to learn a complex language and professional knowledge. Even a person with little-to-no domain or subject-matter knowledge can, accordingly, quickly get started, a threshold is low, and efficiency and a utilization rate of configuration of the metadata can be effectively improved.

Based on the descriptions of the foregoing provided manner of obtaining the metadata for the heterogeneous database, for example, the user may obtain configuration information of the virtual table through configuration performed based on JSON or based on the data configuration interface, and then submit the configuration information of the virtual table to a background service of the query engine. The background service of the query engine obtains the key-value pair based on the submitted configuration information of the virtual table. If configuration is performed based on the JSON, the key-value pair may be directly obtained. If configuration is performed based on the data configuration interface, format conversion may be performed to obtain the key-value pair. The virtual table may be created based on the key-value pair, to obtain the metadata, and the metadata may be updated to a metadata service. The metadata is updated to the metadata service, so that guidance for subsequent query processing can be further provided. If a requirement for creating a new table exists in the configuration, the data table may be automatically created. When the virtual table is created, statements included in the virtual table creation information may be divided into execution tasks when being executed, and support to be visually presented to the user. For example, the virtual table creation information shown above may be divided into two execution tasks shown in FIG. 5D, and completion statuses of the execution tasks may be viewed as shown in FIG. 5D.

In some embodiments, before creating the virtual table by using the plurality of key-value pairs, the computer device may further execute the following content: invoking a permission service to perform authentication processing on the target object, to obtain an authentication processing result; and triggering, if the authentication processing result indicates that the target object has a permission to create the virtual table, performing of the operation of creating a virtual table by using the plurality of key-value pairs.

To ensure access security of the database system, some access permissions may be set for the database system. For example, a limitation that only a user having a management permission can access the database system is set. To ensure security of a data table stored in the database system, a permission may also be set for each data table, thereby limiting access of the user to the data table. For example, an administrator has a viewing permission, an editing permission, a modifying permission, and the like on the data table, and a non-administrator has only the viewing permission but not the editing permission on the data table. In some embodiments, authentication may be performed based on an identifier of the target object. The identifier of the target object is, for example, a user ID. An identifier of each object correspondingly has permission information, and permission information corresponding to the identifier of the target object may be configured for indicating a permission of the target object for each database and a permission for each data table. Content of the authentication processing performed by invoking the permission service herein may include at least one of the following: verifying a permission of the target object to access the first database and the second database, and verifying a permission of the target object to access the first data table and the second data table, to obtain the authentication processing result. The authentication processing result is configured for indicating whether the target object has the permission to create the virtual table. If the authentication processing result indicates that the target object has the permission to create the virtual table, it indicates that the target object has a permission to perform an operation on the first data table and the second data table, so that the computer device can create the virtual table to map the association relationship between the first data table and the second data table. On the contrary, if the authentication processing result indicates that the target object does not have the permission to create the virtual table, it indicates that the target object does not have the permission to perform an operation on the first data table and the second data table. The computer device may not perform the operation of creating a virtual table by using the plurality of key-value pairs. In the foregoing manner, whether the target object has the permission to create the virtual table may be determined through authentication, to allow the computer device to create the virtual table to obtain the metadata when the target object has the permission to create the virtual table, thereby ensuring security of processing the data table.

In some embodiments, the association relationship includes a cold-and-hot relationship. When the computer device stores the at least one piece of data in the first data table into the second data table in the cross-source manner based on the cold-and-hot relationship mapped by the metadata, operations shown in the following S402 and S403 may be performed for implementation.

S402: Obtain, based on an indication of the association relationship mapped by the metadata, a data heating rule corresponding to the first data table.

The association relationship mapped by the metadata may correspond to one or more data processing rules, and any data processing rule may be configured by the user when the key-value pair is configured, or may be configured by a system by default. The data processing rule corresponding to the cold-and-hot relationship mapped by the metadata may include a data heating rule and a data cooling rule. The data cooling rule is configured for indicating to cool data in a hot table, and the data heating rule is configured for indicating to heat data in a cold table.

In some embodiments, the cold-and-hot relationship mapped by the metadata is configured for indicating that the first data table serves as a cold table to store full data in the first database, and the second data table serves as a hot table to store partial data in the first data table. In some embodiments, the computer device may obtain, from the metadata based on an indication of the cold-and-hot relationship, the data heating rule corresponding to the first data table. The data heating rule corresponding to the first data table is configured for indicating to heat the data in the first data table. For example, the metadata is a virtual table, and a storage type included in the virtual table is “partial heating”. It may be determined, based on the metadata, that the data processing rule is the data heating rule corresponding to the first data table. In some embodiments, the computer device may obtain, from a configuration other than the metadata based on the indication of the cold-and-hot relationship, the data heating rule corresponding to the first data table, for example, obtain the data heating rule from a data processing rule configured by the system by default.

S403: Heat at least one piece of data in the first data table according to the data heating rule, and store the heated at least one piece of data into the second data table in the cross-source manner.

In some embodiments, the computer device may automatically generate a data heating task according to the data heating rule, to schedule the data heating task to heat the at least one piece of data in the first data table into the second data table in the second database. In some embodiments, the data heating rule may be configured for indicating an amount of data to be heated, so that a data heating task with an amount the same as the amount of data to be heated may be generated. One data heating task is configured for indicating to heat one piece of data in the first data table into the second data table. When scheduling the data heating task, the computer device may periodically schedule the data heating task based on a preset time interval, or may manually prompt scheduling of the data heating task, to start the data heating task and execute the data heating task. The corresponding metadata may be updated based on the status of the data heating task. The status of the data heating task may be configured for indicating whether the data heating task is finished. The status of the data heating task may include “finished” and “pending.” Updating the metadata may be understood as recording whether the data heating task is finished, for example, updating a partition range of a hot table recorded in the metadata.

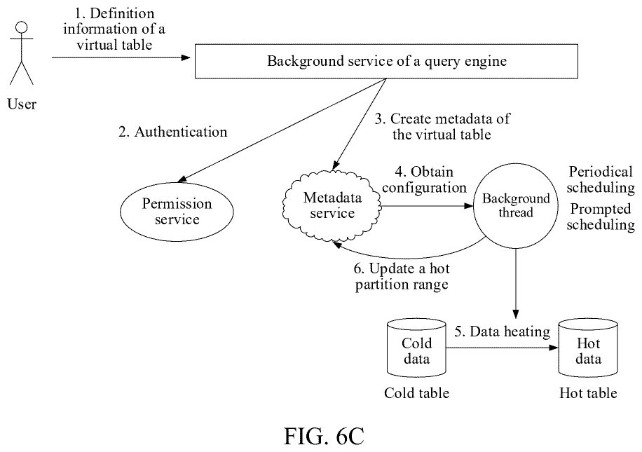

In a data heating process, each data heating task may be viewed based on a task viewing instruction. For example, a task viewing statement about the virtual table may be written on an interface configured for defining the metadata, for example, SHOW VTABLE TASKS FROM oms.test_cold_table_all_type_day. The task viewing statement indicates to view each data heating task generated based on the virtual table oms.test_cold_table_all_type_day. A task executing the task viewing statement and a running property related to the task may be displayed. The running property includes a start time, running duration, and an execution status, as shown in FIG. 6A. As shown in FIG. 6B, each data heating task can be viewed in detail in the statement execution task, and each data heating task has a task identifier (TASK_UUID), a current node identifier (INSTANCE_UUID), a processed partition (PARTITION), a partition format (FORMAT), an event type (SCHEDULE_TYPE), a status (STATUS), an event node (SCHEDULE_NODE), a creation time (CREATE_TIME), a modification time (MODIFY TIME), and the like. Through visual presentation of the foregoing data heating task, the progress of cross-source storage of data to be heated may be learned in real time. For example, data of a cold table in a Hive database system may be heated into a hot table of a starrocks engine by executing the data heating task, and an amount of data on which cross-source storage is currently finished can be learned based on the data heating task.

In some embodiments, heating at least one piece of data in the first data table may be understood as determining or selecting, in the first data table, at least one piece of data to be stored in the cross-source manner, and storing the determined at least one piece of data into the second data table in the cross-source manner. In some embodiments, the first data table stores data in a partitioned manner according to a time unit, different partitions in the first data table correspond to different time points, and interval durations between time points corresponding to two adjacent partitions is one time unit. The time unit herein may be a month, a week, a day, an hour, a minute, or the like. For example, if the first data table stores the data in the partitioned manner every day, the different partitions in the first data table correspond to different days, and the adjacent partitions correspond to adjacent days. In view of a form of partitioned storage in the first data table, data of each partition in the first data table may be referred to as partitioned data for short. For example, the first data table includes partitioned data from 20230101 to 20230510, for example, data of each day from Jan. 1, 2023 to May 10, 2023.

In some embodiments, the data heating rule is configured for indicating that data stored later than a target time point is allowed to be heated, and is periodically heated based on a preset heating frequency, and data stored at P historical time points closest to a current time point is heated each time, where P is a positive integer. The target time point is a time point corresponding to a specified partition in time points corresponding to the partitions in the first data table. For example, the partition corresponding to the target time point is 20230401, which indicates that all data stored after the partition (20230401) corresponding to the target time point can be heated, for example, all data later than Apr. 1, 2023 is allowed to be heated. The preset heating frequency refers to a time interval between adjacent times of data heating. A time unit of the time interval may be the same as or different from the unit of the time point corresponding to the partition. For example, when the preset heating frequency is 2, it indicates that the data in the first data table is heated every two days. The current time point is a time point of heating the first data table, and a unit of the current time point may also be the same as the time unit configured for partitioned storage, for example, Jun. 2, 2023. The data in the partitions corresponding to the P historical time points closest to the current time point may be data in corresponding partitions between the current time point and the target time point. If the current time point is later than the target time point and the P historical time points are greater than a difference between the current time point and the target time point, data in a partition corresponding to a time point before the target time point may be discarded, and only the data in the corresponding partitions between the current time point and the target time point is heated.

Based on an indication of the foregoing data heating rule, when the computer device heats the at least one piece of data in the first data table according to the data heating rule, the computer device may perform the following content: screening out a to-be-heated partition from the first data table based on the indication of the data heating rule, a time point corresponding to the to-be-heated partition being later than the target time point. In some embodiments, if the current time point is later than the target time point, the computer device may use the corresponding partitions between the current time point and the target time point as Q to-be-heated partitions that are screened out, and the partitions are all partitions allowed to be heated in the first data table. For example, the target time point is Apr. 1, 2023, and the current time point is Jun. 1, 2023. Corresponding partitions between Apr. 1, 2023 and Jun. 1, 2023 may be selected, to obtain the Q to-be-heated partitions. If the current time point is earlier than the target time point, the computer device cannot screen out the to-be-heated partition. For example, the target time point is Apr. 1, 2023, and the current time point is Mar. 28, 2023. The to-be-heated partition cannot be screened out.

When the to-be-heated partition is screened out, data of a part or all of the Q to-be-heated partitions may be heated based on the indication of the data heating rule. (1) if the Q to-be-heated partitions are screened out, and QSP, data in the Q to-be-heated partitions is heated. When Q≤P, it indicates that the corresponding partitions in a time period between the current time point and the target time point are insufficient to select the partitions corresponding to the P historical time points closest to the current time point. The data in all the partitions that are screened out can be directly heated. For example, 10 to-be-heated partitions closest to the current time point are screened out, and the data heating rule indicates to each time heat data in partitions corresponding to 20 historical time points closest to the current time point. Data in the 10 to-be-heated partitions may be directly heated, so that the second data table includes the data in the 10 partitions. (2) If Q to-be-heated partitions are screened out, and Q>P, P to-be-heated partitions are selected from the Q to-be-heated partitions based on a time point corresponding to each to-be-heated partition and in a sequence from a later time point to an earlier time point, and data in the P to-be-heated partitions is heated. If Q>P, it indicates that the corresponding partitions in the time period between the current time point and the target time point exceed a quantity of partitions that may be heated. The P to-be-heated partitions closest to the current time point may be selected from the Q to-be-heated partitions, to heat the data in the P to-be-heated partitions. For example, if 30 to-be-heated partitions are selected, and the data heating rule indicates to each time heat data in partitions corresponding to 20 historical time points closest to the current time point. 20 to-be-heated partitions may be selected from the 30 to-be-heated partitions in a sequence from a later corresponding time point to an earlier corresponding time point, and the partitions are 20 partitions corresponding to time points closest to the current time point. When no to-be-heated partition is screened out, it is determined that data heating fails. In some embodiments, a data heating failure prompt may be output on the UI. After viewing the data heating failure prompt, the user may adjust the data heating rule, and the computer device may perform data heating based on an adjusted data heating rule, thereby ensuring valid data heating.

In the foregoing manner, the partitions that support heating are selected based on the target time point and the current time point. The partition to be heated is determined based on a magnitude relationship between a quantity of the partitions that are screened out and a quantity of heated partitions that is indicated by the data heating rule. The data in the partition may be heated into the second data table. The data in the first data table can accordingly be heated under constraint of the data heating rule, and the heated partitioned data is enabled to satisfy a requirement.

In some embodiments, when the computer device heats the at least one piece of data in the first data table according to the data heating rule, the computer device may perform the following content: if the P to-be-heated partitions closest to the current time point can be screened out based on the indication of the data heating rule, the P to-be-heated partitions can be heated; or if M to-be-heated partitions closest to the current time point are screened out, where M is a positive integer less than P, data of the M to-be-heated partitions may be directly heated into the second data table, where the M to-be-heated partitions are screened out by selecting, by using the target time point and the current time point as a screening basis, partitions that are allowed to be heated.

In the foregoing manner, the data in a unit of a partition in the first data table is heated into the second data table, and the second data table also includes the data stored in the partitioned manner according to the time unit. Different partitions in the second data table may correspond to different time points, and interval duration between time points corresponding to two adjacent partitions may be one time unit. In some embodiments, the metadata includes a hot partition range. The hot partition range is a time range including a time point corresponding to the data stored in the second data table in the cross-source manner. After the second data table is updated, based on the hot partition range included in the metadata, the computer device may further obtain a time point corresponding to each piece of data in the updated second data table, and determine a time range including each obtained time point. For example, if the second data table is an empty data table before data heating, after the data in the partitions from 20230101 to 20230515 in the first data table is heated into the second data table, a hot partition range included in the second data table may range from 20230101 to 20230515, in other words, in a time range from Jan. 1, 2023 to May 15, 2023. The hot partition range in the metadata is updated by using the determined time range. Real-time update of the metadata can accordingly be implemented, so that whether to-be-queried data is located in the hot partition range can be accurately determined based on the metadata when the data cross-source query service is subsequently provided, to accurately determine whether related data may need to be queried from the updated second data table, thereby improving accuracy of data query. An updated hot partition range included in the metadata may be the determined time range.

For descriptions of the foregoing procedure of obtaining the metadata and performing data heating based on the cold-and-hot relationship mapped by the metadata, the following flowchart of adaptive data heating shown in FIG. 6C may be provided. It is assumed that a query engine is a SuperSQL engine, and detailed operations involved in the flowchart of data heating include the following content: 1. A user configures definition information of a virtual table (for example, DDL information of the virtual table) based on a UI/JSON, and submits the definition information to a SuperSQL background service. 2. The SuperSQL background service determines whether the user has permission to create the virtual table. 3. When it is determined that the user has permission to create the virtual table, the virtual table is created, and the virtual table is updated to a metadata service as metadata. If there is a requirement for creating a new table in a configuration, a cold table and a hot table are also automatically created. 4. A background thread may obtain an updated audit log of the virtual table, obtain a latest virtual table based on the audit log, and update the virtual table to unified task scheduling. A scheduler may periodically start a data heating task based on a time wheel timer (in which a periodical task is maintained by using a time wheel) or manually prompt to start the data heating task. 5. The data heat task is executed to heat data in the cold table into the hot table. 6. The corresponding metadata is updated based on the status of the data heating task, and hot partition information is updated to the metadata service after each data heating task is finished, for example, a hot partitioning range recorded in the metadata is updated. In the foregoing data heating procedure, the hot data may be automatically loaded to the corresponding engine by using the virtual table configured by the user, a data import procedure may be automatically optimized without a redundant configuration, and an acceleration basis is provided for subsequent querying. The foregoing data heating procedure may also be applicable to procedures such as data backup and data cooling, so that a data backup procedure, a data cooling procedure, and the like may be optimized by using the virtual table.

In some embodiments, the association relationship mapped by the metadata includes a cold-and-hot relationship. The cold-and-hot relationship indicates that the first data table serves as a hot table to store at least one piece of data in the second data table, and the second data table serves as a cold table to store full data in the second database. The computer device may obtain, based on an indication of the association relationship mapped by the metadata, a data cooling rule corresponding to the first data table; cool at least one piece of data in the first data table according to the data cooling rule, and store the cooled at least one piece of data into the second data table in the second database in the cross-source manner. Cooling at least one piece of data in the first data table may also be understood as determining, from the first data table, at least one piece of data to be stored in the cross-source manner. The cooled at least one piece of data may be data heated from another database to the first data table in the first database, or may be data heated from the second database to the first data table included in the first database. The data cooling rule may be obtained from the metadata, or may be obtained from a data processing rule configured by a system by default.

In some embodiments, the first data table stores data in a partitioned manner according to a time unit, different partitions in the first data table correspond to different time points, and interval duration between time points corresponding to two adjacent partitions is one time unit. The data cooling rule indicates how to retain K partitions in the first data table that are closest to the current time point, where K is a positive integer. For example, if K is 7, data in the first data table in last seven days may be retained. When the at least one piece of data in the first data table is cooled into the second data table in the second database according to the data cooling rule, L partitions may be first determined from the first database based on an indication of the data cooling rule. If L is a valid value, for example, L is an integer less than or equal to K, data in the L partitions may be stored in the second data table in the second database in the cross-source manner. If L is an invalid value, for example, 0, it may be determined that data cooling fails.

In both the data cooling down scenario and the data heating scenario, the two data tables distributed in the heterogeneous data may be bound to one virtual table to perform adaptive data processing. For example, as shown in FIG. 6D, in a cold-and-hot data scenario, a Hive table and a StarRocks table may be mapped into a cold-and-hot relationship by using a virtual table. The Hive table, serving as a cold table, includes full data, and the StarRocks table serves as a hot table. In a data cooling scenario, a Hive table and a StarRocks table may be mapped into a cold-and-hot relationship based on a virtual table 1 (vTable 1). Because only partitioned data from 20230301 to 20230315 is retained in a hot table as hot data, partitioned data from 20230101 to 20230228 may be cooled. Data cooling may be understood as that data that is not required in the hot table is duplicated and stored in a cold table (corresponding to the Hive table herein) in the cross-source manner, and the cooled data is deleted from the hot table after the cross-source storage succeeds, to retain only the required hot data. The computer device may automatically adapt to the cold table, and periodically heat partitioned data in the cold table into the hot table based on a configuration. Heating the partitioned data into the hot table may be understood as duplicating the partitioned data into the hot table, where the original partitioned data still exists in the cold table. In a data heating scenario shown in FIG. 6D, a Hive table and a StarRocks table may be mapped into a cold-and-hot relationship based on a virtual table 2 (vTable 2). Data of corresponding partitions from May 1 to May 15 may be heated into the StarRocks. Because data of the Hive is full, and the Hive includes data partitions from 20230101 to 20230515, the StarRocks includes data partitions from 20230501 to 20230515 after data heating.

In some embodiments, the association relationship includes the primary-and-secondary relationship. When storing the at least one piece of data in the first data table into the second data table in the cross-source manner based on the association relationship mapped by the metadata, the computer device may execute the following content: backing up each piece of data in the first data table to the second data table in the second database in the cross-source manner based on the indication of the association relationship mapped by the metadata. In some embodiments, the cross-source backup herein may be understood as that each piece of data in the first data table is duplicated and stored in the second data table included in the second database. The backup of the first data table is backup of full data. If the second data table is an empty table, after each piece of data in the first data table is backed up to the second data table, the updated second data table may be understood as a secondary table (for example, a backup table) of the first data table, and data in the updated second data table may be understood as backup data corresponding to the first data table. If the second data table originally includes the data in the second database, the updated second data table includes the original data and the data that is backed up from the first data table. Through the cross-source backup to the second database system, a plurality of databases may be used to ensure data security. For example, in a case of downtime of the first database, a query service may be provided based on the data that is backed up in the second database and that is from the first database, thereby ensuring data query validity, and effectively dealing with a case in which a database fails and data cannot be queried.

S404: Provide a data cross-source query service by using a query engine based on an updated second data table in the second database.

In some embodiments, based on the cold-and-hot relationship mapped by the metadata, and data heating or data cooling performed in the cold-and-hot relationship, when performing S404, the computer device may perform the following operation 1.1 to operation 1.4.

Operation 1.1: Obtain a first execution plan generated by the query engine.

The first execution plan is generated based on a query statement. Data queried for by using the query statement includes target data located in the first data table. The first execution plan is configured for indicating to scan the first data table to query for the target data. The execution plan may also be referred to as a query execution plan, and may be configured for describing query logic corresponding to data query.

Generation of the first execution plan may include the following operations: The query engine (for example, a SuperSQL engine) may obtain the query statement, where the query statement is configured for indicating to query the first data table for data. For example, an example of the query statement is shown below:

```
  ——simple query
  EXPLAIN SELECT bigint_col, int_col, boolean_col, tinyint_col, float_col
FROM ons.test_cold_table_all_type_day WHERE bigint_col=‘20230528’ AND
boolean_col=true;
  EXPLAIN SELECT bigint_col, int_col, boolean_col, tinyint_col, float_col
FROMons.testcold_table_all_type_day WHERE bigint_col>‘20230528’ and
bigint_col<=‘20230601’ OR bigint_col>‘2023605’ and bigint_col<=‘20230610’;
  EXPLAIN SELECT bigint_col, COUNT(1) FROM
  SELECT bigint_col, int_col, boolean_col, tinyint_col, float_col FROM ons.test
_cold_table_all_type_day WHERE bigint_col>=‘20230528’ and bigint col<‘20230601’ OR
bigint_col>‘20230605’ and bigint_col<=‘20238610’ AND boolean_col=true
  ) t GROUP BY bigint_col ORDER BY bigint_col;
```

The query statement indicates to query the first data table oms.test_cold_table_all_type_day (for example, a cold table) for data and indicates a filter condition to be satisfied for the data query, and is bigint_col>=‘20230528’ and bigint_col<‘20230601’ OR bigint_col>‘20230605’ and bigint_col<=‘20230610’.

The query engine may generate the first execution plan based on the query statement. For example, the following first execution plan is a first execution plan generated based on the query statement in the foregoing example:

```
  PLAN (first execution plan)
  JdbcToEnumerableConverter
  JdbcProject(bigint_col[$4], int_col=[$0], boolean_col=[$1], tinyint_col=[$2],
float_col[$3])
  JdbcFilter(condion=[OR(AND>=$4, ‘20230528’), <($4, ‘20230601’)). AND>($4,
‘20230605’)<=($4, ‘20230610’)))])
  JdbcProject(int_col[$0], boolean_col=[$1], tinyint_col=[$2], float_col=[$5],
bigint_col=[$12])
  JdbcTableScan(table=[[oms.test_cold_table_all_type_day]],
alias=[test_cold_tableall_type_day])
```

The first execution plan is described in detail as follows: jdbcTableScan corresponds to a Hive cold table, the $0^{th}, $1^{st}, $2^{nd}, $5^{th}, and $12^{th} columns are selected to scan data in the cold table, and partitioned data filtering is simultaneously performed based on a partitioned column $4. A filter condition is specifically: bigint_col>=‘20230528’ and bigint_col<‘20230601’ OR bigint_col>‘20230605’ and bigint_col<=‘20230610’. A result is returned.

In some embodiments, a manner in which the query engine generates the first execution plan based on the query statement includes: performing syntax parsing on the query statement, to obtain a parsing result, the parsing result including at least a table identifier of the first data table; performing semantic permission verification based on the table identifier that is of the first data table and that is included in the parsing result, to obtain a verification result, the verification result being configured for indicating whether the first data table exists; and generating the first execution plan based on the parsing result if the verification result indicates that the first data table exists. In some embodiments, syntax parsing may be performed on the query statement to verify whether the first data table exists, and the first execution plan is generated based on the parsing result only when it is determined that the first data table exists. A case in which a processing resource is wasted to generate the first execution plan when the first data table does not exist can be avoided, to improve utilization validity of the processing resource.

In some embodiments, the query engine may invoke a syntax parser to perform syntax parsing on the query statement, to obtain the parsing result. The parsing result includes at least the table identifier of the first data table, for example, includes the name of the first data table. The query engine may invoke a verifier to verify a semantic permission, and may determine, during the semantic permission verification and based on the table identifier of the first data table, whether the first data table exists. If the first data table exists, the first execution plan may be generated based on the parsing result. In some embodiments, the parsing result may be a syntax analysis tree (AST, which is referred to as a syntax abstract tree), and the syntax analysis tree may be converted based on a format of an execution plan, to obtain the first execution plan. If the verification result indicates that the first data table does not exist, the first execution plan cannot be generated.

In some embodiments, the query statement received by the query engine is sent by an executor (which is referred to as a query object for short) of the query operation. The executor of the query operation may be the target object, or may be another object other than the target object. For example, a user A configures a key-value pair on a data configuration interface, and a user B writes a query statement to query for required target data. When metadata configured by the user A works, an execution plan generated based on the query statement may be optimized when an optimization condition is satisfied, thereby providing a better query service. After the semantic permission verification is performed, the query engine may invoke the permission service to authenticate the target object, to obtain an authentication result. The authentication result is configured for indicating whether the query object has a permission to query the first data table. When the authentication result indicates that the query object has the permission to query the first data table, generation of the first execution plan based on the parsing result may be triggered. When the authentication result indicates that the query object does not have the permission to query the first data table, a query failure prompt may be output.

Step 1.2: Obtain a time point corresponding to the target data, and obtain a hot partition range included in the metadata at a current moment.

The first execution plan is an initial execution plan, and an optimizer may start to optimize the first execution plan. That the optimizer starts to optimize the first execution plan may be indicated by setting of a query optimization configuration parameter (for example, a Set parameter). If it indicates to enable a query optimization function, the first execution plan may be optimized when the first execution plan satisfies the optimization condition, to optimize query logic, thereby improving query performance. In some embodiments, the target data queried for in the first data table may include at least one piece of data. Because the data in the first data table is stored in the partitioned manner according to the time unit, the target data that is queried for corresponds to a time point. The computer device may obtain, from the first data table, the time point corresponding to the target data, and may obtain, from the metadata, the hot partition range included at the current moment, for example, a time range including time points corresponding to the data in the latest second data table. Whether to optimize the first execution plan may be determined based on a relationship between the time point corresponding to the target data and the time range corresponding to the hot partition range.

Step 1.3: Optimize the first execution plan to obtain a second execution plan if the obtained time point is within the obtained hot partition range.

In some embodiments, when the time point corresponding to the target data is within the hot partition range included in the metadata at the current moment, it indicates that the required target data may also be found from the updated second data table, so that the computer device may optimize the first execution plan to obtain the second execution plan. The second execution plan is configured for indicating to scan the updated second data table to query for the target data.

In some embodiments, the first execution plan includes a table field and a column field. The table field stores the table identifier of the first data table. The column field stores a column identifier of a data column to be scanned in the first data table. When optimizing the first execution plan to obtain the second execution plan, the computer device may execute the following content: updating the table identifier stored in the table field in the first execution plan from the table identifier of the first data table to a table identifier of the second data table; and determining a target data column in the updated second data table based on the data column to be scanned in the first data table, the target data column and the data column to be scanned in the first data table storing same data. For example, the data columns to be scanned in the first data table are the $0^{th}, $1^{st}, $2^{nd}, $5^{th}, and $12^{th} columns. Based on a principle of querying for same data, the target data columns storing the same data may be determined from the updated second data table, such as the $0^{th}, $1^{st}, $2^{nd}, $3^{rd}, and $6^{th} columns. The column identifier stored in the column field in the first execution plan may be updated from the column identifier of the data column to be scanned in the first data table to a column identifier of the target data column; and an updated first execution plan is used as the second execution plan after the table field and the column field in the first execution plan are updated. For example, after the first execution plan shown above is optimized, the second execution plan may be obtained. Content of the second execution plan is shown as follows:

```
  PLAN (second execution plan)
  JdbcToEnumerableConverter
  JdbcProject(bigint_col[$0], int_col=[$1], boolean_col=[$2], tinyint_col=[$3],
float_col[$4])
  JdbcFilter(condion=[OR(AND>=$0, ‘20230528’), <($0, ‘20230601’)).AND>($0,
‘20230605’)<=($0, ‘20230610’)))])
  JdbcProject(bigint_col=[$0], int_col=[$1], boolean_col=[$2], tinyint_col=[$3],
float_col=[$6])
  JdbcTableScan(table=starrocks_teg_test_gz_root, test_hot_table_all_type_day]])
```

As shown above, the second execution plan is described in detail as follows: jdbcTableScan corresponds to a hot table, the $0^{th}, $1^{st}, $2^{nd}, $3^{rd}, and $6^{th} columns are selected to scan the hot table, and partitioned filtering is simultaneously performed based on a partitioned column $0. A filter condition is specifically: bigint_col>=‘20230528’ and bigint_col<‘20230601’ OR bigint_col>‘20230605’ and bigint_col<=‘20230610’. The result is returned. It can be learned from the foregoing descriptions that, in some embodiments, the table field and the column field are set in the first execution plan, so that the first execution plan can be subsequently optimized into the second execution plan by updating the table identifier in the table field and the column identifier in the column field. An optimization operation of the execution plan can be simplified, thereby improving efficiency of optimizing the execution plan.

If none of the time points corresponding to the target data included in the data that is queried for in the first data table is within the hot partition range included in the metadata at the current moment, the computer device may directly invoke the query engine to execute the first execution plan, to obtain the target data without optimizing the first execution plan.

Operation 1.4: Invoke the query engine to execute the second execution plan, to obtain the target data.

In some embodiments, the computer device may invoke an executor in the query engine to execute the second execution plan. Based on execution of the second execution plan, the computer device may invoke the query engine to find the target data from the updated second data table. The found target data may also be understood as a computing result. The computing result may be returned to the optimizer, to obtain the target data to be queried.

If the data that is queried for further includes data in the second data table in addition to the target data in the first data table, data of the two data sources may be obtained from one database when query is performed after the first execution plan is optimized. If only a part of the target data included in the data that is queried for in the first data table is located in the second data table, plan optimization may also be performed. A part of data is queried for from the updated second data table included in the second database, and a remaining part of data is queried for from the first data table included in the first database. The data found in the first data table and the data found in the updated second data table are combined, to obtain the final computing result. Cross-source query is also implemented in the entire process. In comparison with the first database, the second database has a better computing capability and has a higher degree of adaptation to the query engine, and a query speed based on the second data table is faster than a query speed based on the first data table. In comparison with querying only in the first data table before optimization, a query speed can accordingly be improved to some extent when the second data table is queried for the required target data, thereby improving query efficiency.

An essence of optimizing the first execution plan is to perform equivalent transformation on the first execution plan. The table identifier in the first execution plan is updated, so that the first data table may be replaced with the second data table as a data table scanned during query. The column identifier in the first execution plan is updated, so that a correlation relationship of column mapped during data query can be modified, and the second execution plan is finally obtained. For example, in the cold-and-hot data scenario, because a query speed of the StarRocks is far faster than (more than 10 times of) a query speed of the Hive, the query speed may be greatly improved based on the optimization of the first execution plan.

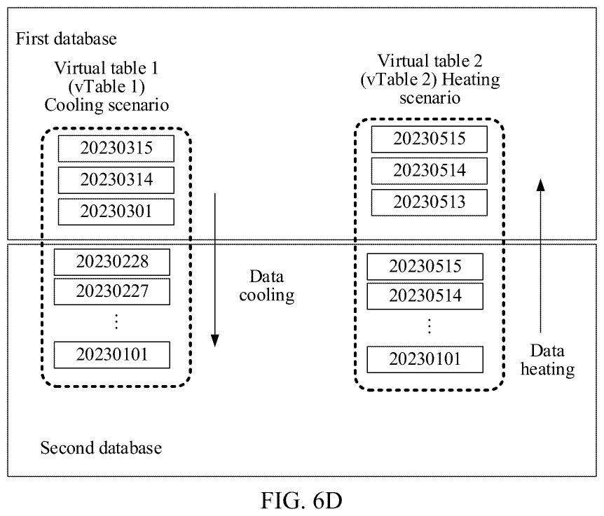

Based on the foregoing introduced content, a flowchart of adaptive query acceleration shown in FIG. 7 may be provided. A query engine is a SuperSQL engine, and a background service of the query engine is a background service (for example, a SuperSQL background service) provided by the SuperSQL engine. Detailed operations of the foregoing flowchart include the following content: 1. A user sends a query statement (such as an SQL statement) to the SuperSQL background service. 2. The SuperSQL background service parses syntax and verifies a semantic permission and the like, which specifically includes 2.1. authentication performed by using a permission service and 2.2. semantic verification interacting with a metadata service. 3. An optimizer starts to optimize an initial execution plan. 4. An optimization policy in the optimizer may be optimized based on a partition range included in a cold table and a partition range included in a hot table that are in obtained metadata. 5. When it is determined that the target data that of the query is included in a hot partition range, equivalent transformation of the execution plan is performed. The cold table in the execution plan may be replaced with the hot table, and a correlation relationship between mapped columns is modified. 6. An optimized execution plan is sent to an execution engine for execution. 7. Return an accelerated computing result.

In the foregoing query acceleration process, query acceleration in the cold-and-hot data scenario may be implemented based on the hot partition range provided by the metadata, and a threshold for a user to use query acceleration is lowered based on a simple configuration of the metadata. Accordingly, acceleration rule principles do not need to be learned as that in a materialized view, and query acceleration may be performed based on cold-and-hot data of an adaptive heterogeneous engine, to reduce costs and improve efficiency.

In some embodiments, based on the primary-and-secondary relationship mapped by the metadata and the cross-source backup for the first data table, when performing S404, the computer device may perform the following operation 2.1 to operation 2.4.

Operation 2.1: Obtain a first execution plan generated by the query engine. The first execution plan is generated based on a query statement. Data queried for by using the query statement includes target data located in the first data table. The first execution plan is configured for indicating to scan the first data table to query for the target data. In some embodiments, for a manner in which the query engine generates the first execution plan based on the query statement, refer to related content described in the foregoing cold-and-hot relationship. In the primary-and-secondary relationship, the first data table is a primary table, and the second data table is a secondary table.

Operation 2.2: Obtain a running status that is of the first data table and that is at the current moment.

The current moment is a moment at which the first execution plan is obtained. The running status that is of the first data table and that is at the current moment may be configured for indicating whether the first data table is normal or abnormal when the computer device obtains the first execution plan. In some embodiments, the computer device may obtain the running status that is of the first data table and that is at the current moment from the metadata. In some embodiments, the running status that is of the first data table and that is at the current moment is maintained in a dedicated status data table. The computer device may obtain the running status that is of the first data table and that is at the current moment from the status data table. The status data table further maintains the latest running status of another data table, so that when the other data table is processed, the running status that is of the corresponding data table and that is at the current moment may also be obtained from the status data table.

Operation 2.3: Optimize the first execution plan to obtain the second execution plan if the running status is an abnormal state.

Operation 2.4: Invoke the query engine to execute the second execution plan, to obtain the target data.

If the running status is the abnormal state, it indicates that the first data table is exceptionally processed and cannot be accessed. The required target data may not be found according to the first execution plan. To ensure query validity, the first execution plan may be optimized to obtain the second execution plan. For additional implementation details of optimizing the first execution plan, refer to the manner of optimizing the first execution plan in the cold-and-hot relationship. The second execution plan is the optimized first execution plan. The second execution plan is configured for indicating to scan the updated second data table to query for the target data. In the primary-and-secondary relationship, when the primary table is in the abnormal state and the data cannot be found, the required target data may accordingly be found in the secondary table by modifying the first execution plan. If the running status that is of the first data table and that is at the current moment is a normal state, the first execution plan may not be optimized, but the query engine is invoked to execute the first execution plan, to obtain the target data.

According to the data processing method provided the data heating rule corresponding to the first data table is obtained based on the indication of the association relationship mapped by the metadata, and the at least one piece of data in the first data table is heated into the second data table according to the data heating rule, to implement cross-source storage of the data. When the target data that is queried for relates to the data in the first data table, the execution plan is optimized, so that the updated data table can be queried for the data, thereby improving a speed when the data is queried for in the data heating scenario. When the metadata maps the primary-and-secondary relationship, all the data in the first data table may be backed up to the second database in the cross-source manner, so that when it logically indicates to query for the data in the primary table, but the data cannot be found, the execution plan may be optimized, to query the secondary table for the requested data, thereby ensuring that the data can be accurately found. The data processing method may be further promoted to another optimization scenario, for example, a scenario such as a materialized view and data union. In these scenarios, a computer device may receive information submitted by a user to generate virtual table creation information, and a background generates metadata based on the virtual table creation information, thereby adaptively performing data processing based on the metadata and providing a data query service with better performance.

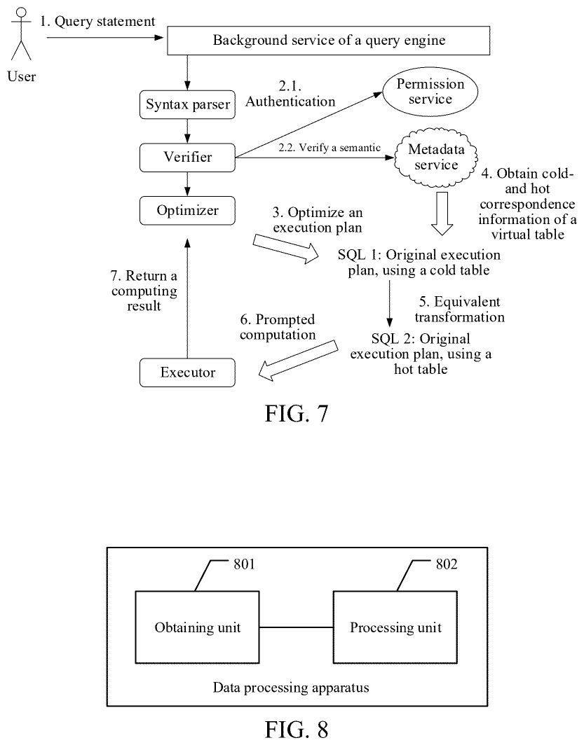

Based on the descriptions of some embodiments of the data processing method, some embodiments further discloses a data processing apparatus. The data processing apparatus may be a computer program (including program code) run in a computer device, and the data processing apparatus may perform the operations in the method procedure shown in FIG. 2 or FIG. 4. Referring to FIG. 8, the data processing apparatus may perform the following units:

an obtaining unit 801, configured to obtain metadata configured for a heterogeneous database, the heterogeneous database including a first database and a second database, the metadata being configured for mapping an association relationship between a first data table and a second data table, the first data table being located in the first database, and the second data table being located in the second database; and

a processing unit 802, configured to store at least one piece of data in the first data table into the second data table in a cross-source manner based on the association relationship mapped by the metadata, to update the second data table;

the processing unit 802 being further configured to provide a data cross-source query service by using a query engine based on an updated second data table in the second database.

In some embodiments, when obtaining the metadata configured for the heterogeneous database, the obtaining unit 801 may be configured to:

obtain a plurality of key-value pairs configured by a target object for the heterogeneous database, the plurality of key-value pairs including at least a key-value pair configured for indicating the first data table, a key-value pair configured for indicating the second data table, and a key-value pair configured for indicating the association relationship between the first data table and the second data table; and

create a virtual table by using the plurality of key-value pairs, and use the created virtual table as the metadata configured for the heterogeneous database.

In some embodiments, when obtaining the plurality of key-value pairs configured by the target object for the heterogeneous database, the obtaining unit 801 may be configured to:

display a data configuration interface of the heterogeneous database, the data configuration interface including at least the following configuration items: a configuration item configured for configuring the first data table, a configuration item configured for configuring the second data table, and a configuration item configured for configuring the association relationship between the first data table and the second data table;

display, based on a configuration operation performed by the target object on each configuration item on the data configuration interface, configuration information of the corresponding configuration item; and

perform, in response to a configuration ending operation, format conversion on the currently displayed configuration information of each configuration item based on data formats of the key-value pairs, to obtain the plurality of key-value pairs configured by the target object for the heterogeneous database.

In some embodiments, the processing unit 802 is further configured to:

invoke a permission service to perform authentication processing on the target object, to obtain an authentication processing result; and

trigger, if the authentication processing result indicates that the target object has a permission to create the virtual table, performing the operation of creating a virtual table by using the plurality of key-value pairs.

In some embodiments, the association relationship includes at least one of a cold-and-hot relationship, a union relationship, a primary-and-secondary relationship, and a materialized-view relationship.

The cold-and-hot relationship is configured for indicating that the first data table serves as a cold table to store full data in the first database, and the second data table serves as a hot table to store partial data in the first data table.

The union relationship is configured for indicating that the first data table and the second data table unite to form full data in the first database.

The primary-and-secondary relationship is configured for indicating that the first data table serves as a primary table to store full data in the first database, and the second data table serves as a secondary table to back up the data in the first data table.

The materialized-view relationship is configured for indicating that the second data table is configured for storing result data obtained by performing pre-calculation on the first data table.

In some embodiments, the association relationship includes the cold-and-hot relationship. When storing the at least one piece of data in the first data table into the second data table in the cross-source manner based on the association relationship mapped by the metadata, the processing unit 802 may be configured to:

obtain, based on an indication of the association relationship mapped by the metadata, a data heating rule corresponding to the first data table; and

heat at least one piece of data in the first data table according to the data heating rule, and store the heated at least one piece of data into the second data table in the cross-source manner.

In some embodiments, the first data table stores data in a partitioned manner according to a time unit, different partitions in the first data table correspond to different time points, and interval duration between time points corresponding to two adjacent partitions is one time unit. The data heating rule is configured for indicating that data stored later than a target time point is allowed to be heated, and is periodically heated based on a preset heating frequency, and data in partitions corresponding to P historical time points closest to a current time point is heated each time, where P is a positive integer.

In some embodiments, when heating the at least one piece of data in the first data table according to the data heating rule, the processing unit 802 may be configured to:

screen out a to-be-heated partition from the first data table based on an indication of the data heating rule, a time point corresponding to the to-be-heated partition being later than the target time point; and

if Q to-be-heated partitions are screened out, and Q≤P, heat data in the Q to-be-heated partitions, Q being a positive integer;

if Q to-be-heated partitions are screened out, and Q>P, select P to-be-heated partitions from the Q to-be-heated partitions based on a time point corresponding to each to-be-heated partition and in a sequence from a later time point to an earlier time point, and heat data in the P to-be-heated partitions; or

if no to-be-heated partition is screened out, determine that data heating fails.

In some embodiments, the metadata includes a hot partition range, and the hot partition range is a time range including a time point corresponding to the data stored in the second data table in the cross-source manner. After updating the second data table, the processing unit 802 is further configured to:

obtain a time point corresponding to each piece of data in the updated second data table, and determine a time range including each obtained time point; and

update the hot partition range in the metadata by using the determined time range.

In some embodiments, when providing the data cross-source query service by using the query engine based on the updated second data table in the second database, the processing unit 802 may be configured to:

obtain a first execution plan generated by the query engine, the first execution plan being generated based on a query statement; data queried for by using the query statement including target data located in the first data table; and the first execution plan being configured for indicating to scan the first data table to query for the target data;

obtain a time point corresponding to the target data, and obtain a hot partition range included in the metadata at a current moment;

optimize the first execution plan to obtain a second execution plan if the obtained time point is within the obtained hot partition range, the second execution plan being configured for indicating to scan the updated second data table to query for the target data; and

invoke the query engine to execute the second execution plan, to obtain the target data.

In some embodiments, the association relationship includes the primary-and-secondary relationship. When storing the at least one piece of data in the first data table into the second data table in the cross-source manner based on the association relationship mapped by the metadata, the processing unit 802 may be configured to:

back up each piece of data in the first data table to the second data table in the cross-source manner based on the indication of the association relationship mapped by the metadata.

In some embodiments, when providing the data cross-source query service by using the query engine based on the updated second data table in the second database, the processing unit 802 may be configured to:

obtain a first execution plan generated by the query engine, the first execution plan being generated based on a query statement; data queried for by using the query statement including target data located in the first data table; and the first execution plan being configured for indicating to scan the first data table to query for the target data;

obtain a running status that is of the first data table and that is at the current moment, the current moment being a moment at which the first execution plan is obtained;

optimize the first execution plan to obtain the second execution plan if the running status is an abnormal state, the second execution plan being configured for indicating to scan the updated second data table to query for the target data; and

invoke the query engine to execute the second execution plan, to obtain the target data.

In some embodiments, a manner in which the query engine generates the first execution plan based on the query statement includes:

performing syntax parsing on the query statement, to obtain a parsing result, the parsing result including at least a table identifier of the first data table;

performing semantic permission verification based on the table identifier that is of the first data table and that is included in the parsing result, to obtain a verification result, the verification result being configured for indicating whether the first data table exists; and

generating the first execution plan based on the parsing result if the verification result indicates that the first data table exists.

In some embodiments, the first execution plan includes a table field and a column field. The table field stores the table identifier of the first data table. The column field stores a column identifier of a data column to be scanned in the first data table. When optimizing the first execution plan to obtain the second execution plan, the processing unit 802 may be configured to:

update the table identifier stored in the table field in the first execution plan from the table identifier of the first data table to a table identifier of the second data table;

determine a target data column in the updated second data table based on the data column to be scanned in the first data table, the target data column and the data column to be scanned in the first data table storing same data;

update the column identifier stored in the column field in the first execution plan from the column identifier of the data column to be scanned in the first data table to a column identifier of the target data column; and

use an updated first execution plan as the second execution plan after the table field and the column field in the first execution plan are updated.

According to the data processing method provided the association relationship between the plurality of data tables may be mapped by the metadata, thereby implementing binding between the data tables of the heterogeneous database, and providing an optimization basis for data cross-source query. A part or all of data in the first data table included in the first database is stored in the second data table in the second database in the cross-source manner based on the association relationship mapped by the metadata, so that the second database has data of another data source. When the data in the first data table and the second data table (for example, data distributed in the heterogeneous database) are queried in the cross-source manner, the requested data can accordingly be found only by accessing the second database, and the efficiency of cross-source querying may be improved. If the data queried relates to the data in the first data table, a data query can also be implemented by accessing the second data table in the second database based on cross-source storage of the data in the first data table, so that a requirement in a corresponding query scenario is satisfied.

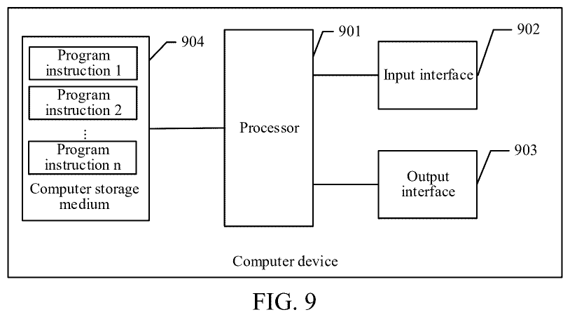

Based on the descriptions of the method embodiment and some embodiments, some embodiments further provide a computer device. Referring to FIG. 9, the computer device includes at least a processor 901, an input interface 902, an output interface 903, and a computer storage medium 904. The processor 901, the input interface 902, the output interface 903, and the computer storage medium 904 may be connected by using a bus or in another manner. The computer storage medium 904 may be stored in a memory of the computer device. The computer storage medium 904 is configured to store a computer program. The computer program includes program instructions. The processor 901 is configured to execute the program instructions stored in the computer storage medium 904. The processor 901 (which is alternatively referred to as a central processing unit (CPU)) is a computing core and a control core of computer device, and is configured to implement one or more instructions, configured to load and execute the one or more instructions, to implement a corresponding method procedure or a corresponding function.

In some embodiments, the processor 901 in some embodiments may be configured to:

obtain metadata configured for a heterogeneous database, the heterogeneous database including a first database and a second database, the metadata being configured for mapping an association relationship between a first data table and a second data table, the first data table being located in the first database, and the second data table being located in the second database;

store at least one piece of data in the first data table into the second data table in a cross-source manner based on the association relationship mapped by the metadata, to update the second data table; and

provide a data cross-source query service by using a query engine based on an updated second data table in the second database.

In some embodiments, when the metadata configured for the heterogeneous database is obtained, one or more instructions in the computer storage medium may be loaded by the processor 901 to perform the following operations:

obtaining a plurality of key-value pairs configured by a target object for the heterogeneous database, the plurality of key-value pairs including at least a key-value pair configured for indicating the first data table, a key-value pair configured for indicating the second data table, and a key-value pair configured for indicating the association relationship between the first data table and the second data table; and

creating a virtual table by using the plurality of key-value pairs, and using the created virtual table as the metadata configured for the heterogeneous database.

In some embodiments, when the plurality of key-value pairs configured by the target object for the heterogeneous database are obtained, one or more instructions in the computer storage medium may be loaded by the processor 901 to perform the following operations:

displaying a data configuration interface of the heterogeneous database, the data configuration interface including at least the following configuration items: a configuration item configured for configuring the first data table, a configuration item configured for configuring the second data table, and a configuration item configured for configuring the association relationship between the first data table and the second data table;

displaying, based on a configuration operation performed by the target object on each configuration item on the data configuration interface, configuration information of the corresponding configuration item; and

performing, in response to a configuration ending operation, format conversion on the currently displayed configuration information of each configuration item based on data formats of the key-value pairs, to obtain the plurality of key-value pairs configured by the target object for the heterogeneous database.

In some embodiments, one or more instructions in the computer storage medium may be loaded by the processor 901 to perform the following operations:

invoking a permission service to perform authentication processing on the target object, to obtain an authentication processing result; and

triggering, if the authentication processing result indicates that the target object has a permission to create the virtual table, performing of the operation of creating a virtual table by using the plurality of key-value pairs.

In some embodiments, the association relationship includes at least one of a cold-and-hot relationship, a union relationship, a primary-and-secondary relationship, and a materialized-view relationship.

The cold-and-hot relationship is configured for indicating that the first data table serves as a cold table to store full data in the first database, and the second data table serves as a hot table to store partial data in the first data table.

The union relationship is configured for indicating that the first data table and the second data table unite to form full data in the first database.

The primary-and-secondary relationship is configured for indicating that the first data table serves as a primary table to store full data in the first database, and the second data table serves as a secondary table to back up the data in the first data table.

The materialized-view relationship is configured for indicating that the second data table is configured for storing result data obtained by performing pre-calculation on the first data table.

In some embodiments, the association relationship includes the cold-and-hot relationship. When the at least one piece of data in the first data table is stored in the second data table in the cross-source manner based on the association relationship mapped by the metadata, one or more instructions in the computer storage medium may be loaded by the processor 901 to perform the following operations:

obtaining, based on an indication of the association relationship mapped by the metadata, a data heating rule corresponding to the first data table; and

heating at least one piece of data in the first data table according to the data heating rule, and storing the heated at least one piece of data into the second data table in the cross-source manner.

In some embodiments, the first data table stores data in a partitioned manner according to a time unit, different partitions in the first data table correspond to different time points, and interval duration between time points corresponding to two adjacent partitions is one time unit. The data heating rule is configured for indicating that data stored later than a target time point is allowed to be heated, and is periodically heated based on a preset heating frequency, and data in partitions corresponding to P historical time points closest to a current time point is heated each time, where P is a positive integer.

In some embodiments, when the at least one piece of data is heated in the first data table according to the data heating rule, one or more instructions in the computer storage medium may be loaded by the processor 901 to perform the following operations:

screening out a to-be-heated partition from the first data table based on an indication of the data heating rule, a time point corresponding to the to-be-heated partition being later than the target time point; and

if Q to-be-heated partitions are screened out, and Q≤P, heating data in the Q to-be-heated partitions, Q being a positive integer;

if Q to-be-heated partitions are screened out, and Q>P, selecting P to-be-heated partitions from the Q to-be-heated partitions based on a time point corresponding to each to-be-heated partition and in a sequence from a later time point to an earlier time point, and heating data in the P to-be-heated partitions; or

if no to-be-heated partition is screened out, determining that data heating fails.

In some embodiments, the metadata includes a hot partition range, and the hot partition range is a time range including a time point corresponding to the data stored in the second data table in the cross-source manner. After the second data table is updated, one or more instructions in the computer storage medium may be loaded by the processor 901 to perform the following operations:

obtaining a time point corresponding to each piece of data in the updated second data table, and determining a time range including each obtained time point; and

updating the hot partition range in the metadata by using the determined time range.

In some embodiments, when the data cross-source query service is provided by using the query engine based on the updated second data table in the second database, one or more instructions in the computer storage medium may be loaded by the processor 901 to perform the following operations:

obtaining a first execution plan generated by the query engine, the first execution plan being generated based on a query statement; data queried for by using the query statement including target data located in the first data table; and the first execution plan being configured for indicating to scan the first data table to query for the target data;

obtaining a time point corresponding to the target data, and obtaining a hot partition range included in the metadata at a current moment;

optimizing the first execution plan to obtain a second execution plan if the obtained time point is within the obtained hot partition range, the second execution plan being configured for indicating to scan the updated second data table to query for the target data; and

invoking the query engine to execute the second execution plan, to obtain the target data.

In some embodiments, the association relationship includes the primary-and-secondary relationship. When the at least one piece of data in the first data table is stored in the second data table in the cross-source manner based on the association relationship mapped by the metadata, one or more instructions in the computer storage medium may be loaded by the processor 901 to perform the following operations:

backing up each piece of data in the first data table to the second data table in the cross-source manner based on the indication of the association relationship mapped by the metadata.

In some embodiments, when the data cross-source query service is provided by using the query engine based on the updated second data table in the second database, one or more instructions in the computer storage medium may be loaded by the processor 901 to perform the following operations:

obtaining a first execution plan generated by the query engine, the first execution plan being generated based on a query statement; data queried for by using the query statement including target data located in the first data table; and the first execution plan being configured for indicating to scan the first data table to query for the target data;

obtaining a running status that is of the first data table and that is at the current moment, the current moment being a moment at which the first execution plan is obtained;

optimizing the first execution plan to obtain the second execution plan if the running status is an abnormal state, the second execution plan being configured for indicating to scan the updated second data table to query for the target data; and

invoking the query engine to execute the second execution plan, to obtain the target data.

In some embodiments, a manner in which the query engine generates the first execution plan based on the query statement includes:

performing syntax parsing on the query statement, to obtain a parsing result, the parsing result including at least a table identifier of the first data table;

performing semantic permission verification based on the table identifier that is of the first data table and that is included in the parsing result, to obtain a verification result, the verification result being configured for indicating whether the first data table exists; and

generating the first execution plan based on the parsing result if the verification result indicates that the first data table exists.

In some embodiments, the first execution plan includes a table field and a column field. The table field stores the table identifier of the first data table. The column field stores a column identifier of a data column to be scanned in the first data table. When the first execution plan is optimized to obtain the second execution plan, one or more instructions in the computer storage medium may be loaded by the processor 901 to perform the following operations:

updating the table identifier stored in the table field in the first execution plan from the table identifier of the first data table to a table identifier of the second data table;

determining a target data column in the updated second data table based on the data column to be scanned in the first data table, the target data column and the data column to be scanned in the first data table storing same data;

updating the column identifier stored in the column field in the first execution plan from the column identifier of the data column to be scanned in the first data table to a column identifier of the target data column; and

using an updated first execution plan as the second execution plan after the table field and the column field in the first execution plan are updated.

According to the data processing method provided the association relationship between the plurality of data tables may be mapped by the metadata, thereby implementing binding between the data tables of the heterogeneous database, and providing an optimization basis for data cross-source query. A part or all of data in the first data table included in the first database is stored in the second data table in the second database in the cross-source manner based on the association relationship mapped by the metadata, so that the second database has data of another data source. When the data in the first data table and the second data table (for example, data distributed in the heterogeneous database) are queried in the cross-source manner, the requested data can accordingly be found only by accessing the second database, and the efficiency of cross-source querying may be improved. If the data to be queried relates to the data in the first data table, data query can also be implemented by accessing the second data table in the second database based on cross-source storage of the data in the first data table, so that a requirement in a corresponding query scenario is satisfied.

Some embodiments further provide a computer storage medium. The computer storage medium stores a computer program, and the computer program includes program instructions. When executing the foregoing program instructions, a processor can perform the methods in some embodiments corresponding to FIG. 2 and FIG. 4, for example. Therefore, for additional implementation details, reference may be made to the descriptions of FIGS. 2 and 4. For additional implementation details of the computer storage medium, reference may also be made to the descriptions of the method embodiments, for example. The program instructions may be deployed on a computer device, or executed on a plurality of computer devices located at the same location. The program instructions may be executed on a plurality of computer devices that are connected through a communication network and that are distributed at a plurality of positions

According to some embodiments, a computer program product is provided. The computer program product includes a computer program, and the computer program is stored in a computer storage medium. A processor of a computer device reads the computer program from the computer storage medium, and the processor executes the computer program, to enable the computer device to perform the methods described with respect to FIG. 2 and FIG. 4. Therefore, for additional implementation details, reference may be made to the descriptions of FIGS. 2 and 4.

A person of ordinary skill in the art is to understand that all or a part of the processes of the method in some embodiments may be implemented by a program instructing relevant hardware. The program may be stored in a computer readable storage medium. When the program is run, the processes of the method in some embodiments are performed. The foregoing storage medium may be a magnetic disk, an optical disc, a read-only memory (ROM), or a random access memory (RAM).

Some embodiments are used for describing, instead of limiting some embodiments of the disclosure. A person of ordinary skill in the art shall understand that although the disclosure has been described in detail with reference to some embodiments, modifications can be made to some embodiments described in some embodiments, or equivalent replacements can be made to some technical features in some embodiments, provided that such modifications or replacements do not cause the essence of corresponding technical solutions to depart from the spirit and scope of some embodiments of some embodiments of the disclosure and the appended claims.

What is claimed is:

1. A data processing method, comprising:
obtaining metadata for a heterogeneous database comprising a first database and a second database, wherein the metadata maps an association relationship between a first data table of the first database and a second data table of the second database;
updating the second data table by storing, in a cross-source operation, data from the first data table in the second data table based on the association relationship;
receiving a query statement indicating the first data table; and
executing the query statement on the updated second data table to obtain a query result indicating at least one piece of the data from the first data table.

2. The data processing method according to claim 1, wherein the obtaining the metadata comprises:
obtaining a plurality of key-value pairs comprising: a key-value pair indicating the first data table, a key-value pair indicating the second data table, and a key-value pair indicating the association relationship between the first data table and the second data table; and
creating a virtual table based on the plurality of key-value pairs, and using the virtual table as the metadata.

3. The data processing method according to claim 1, wherein the obtaining the plurality of key-value pairs comprises:
displaying a data configuration interface for the heterogeneous database comprising at least one configuration item from among: a first configuration item for configuring the first data table, a second configuration item for configuring the second data table, and a third configuration item for configuring the association relationship;
displaying, in response to receiving an instruction for configuring the at least one configuration item, configuration information of the at least one configuration item;
performing, in response to receiving an instruction for ending configuration, format conversion on the configuration information based on a data format for a corresponding key-value pair; and
generating the plurality of key-value pairs based on the configuration with the applied format conversion.

4. The data processing method according to claim 2, further comprising:
invoking a permission service to perform authentication processing to determine whether a target object has permission to create the virtual table;
receiving an authentication result from the permission service; and
triggering, based on the authentication result indicating that the target object has permission to create the virtual table, creation of the virtual table using the plurality of key-value pairs.

5. The data processing method according to claim 1, wherein the association relationship comprises at least one of a cold-and-hot relationship, a union relationship, a primary-and-secondary relationship, and a materialized-view relationship, wherein
the cold-and-hot relationship indicates that the first data table stores full data in the first database, and the second data table stores partial data from the first data table;
the union relationship indicates that the first data table and the second data table unite to form full data in the first database;
the primary-and-secondary relationship indicates that the first data table stores full data in the first database, and the second data table stores backup data for the first data table; and
the materialized-view relationship indicates that the second data table stores result data obtained from pre-calculations performed on the first data table.

6. The data processing method according to claim 5, wherein the association relationship comprises the cold-and-hot relationship, and wherein the updating the second data table comprises:
obtaining, based on the cold-and-hot relationship mapped by the metadata, a data heating rule corresponding to the first data table; and
heating at least one piece of data from the first data table according to the data heating rule, and storing, in the second data table, in the cross-source operation, the heated at least one piece of data from the first data table.

7. The data processing method according to claim 6, wherein the data from the first data table is partitioned such that partitions of the first data table correspond to different time points, and an interval between adjacent partitions corresponds to a duration of one time unit, and
wherein the data heating rule indicates that:
data stored later than a target time point is eligible for heating, and
data in one or more partitions corresponding to one or more historical time points closest to a current time point is periodically heated at a preset heating frequency.

8. The data processing method according to claim 7, wherein the heating the at least one piece of data comprises:
screening one or more to-be-heated partitions from the first data table based on the data heating rule, wherein time points corresponding to the one or more to-be-heated partitions are later than the target time point;
if at least one of the one or more to-be-heated partitions is screened out:
if a number of the at least one screened out partition is less than or equal to a number of the one or more historical time points, heating data in the at least one screened out partition; and
if the number of the at least one screened out partition is greater than the number of the one or more historical time points, selecting from among the at least one screened out partition, a number of partitions equal to the number of the one or more historical time points, the selected at least one screened out partition corresponding to most recent historical time points; and
heating data in the at least one screened out partition; and
if no to-be-heated partition is screened out, determining that data heating has failed.

9. The data processing method according to claim 6, wherein the metadata comprises a hot partition range that includes a time point corresponding to data stored in the second data table in the cross-source operation, and
wherein the data processing method further comprises:
obtaining a plurality of time points corresponding to a plurality of pieces of data in the updated second data table, and determining a time range comprising the plurality of time points; and
updating the hot partition range based on the determined time range.

10. The data processing method according to claim 1, wherein the executing the query statement comprises:
generating, based on the query statement, a first execution plan indicating to scan the first data table to obtain the target data, wherein the query statement indicates target data located in the first data table;
obtaining a time point corresponding to the target data, and obtaining a hot partition range from the metadata at a current time point;
based on the obtained time point being within the obtained hot partition range, optimizing the first execution plan to obtain a second execution plan indicating to scan the updated second data table to obtain the target data; and
obtaining the target data by executing the second execution plan.

11. A data processing apparatus, comprising:
at least one memory configured to store computer program code; and
at least one processor configured to read the program code and operate as instructed by the program code, the program code comprising:
obtaining code configured to cause at least one of the at least one processor to obtain metadata for a heterogeneous database comprising a first database and a second database, wherein the metadata maps an association relationship between a first data table of the first database and a second data table of the second database; and
updating code configured to cause at least one of the at least one processor to update the second data table by storing, in a cross-source operation, data from the first data table in the second data table based on the association relationship; and
query code configured to cause at least one of the at least one processor to:
receive a query statement indicating the first data table; and
execute the query statement on the updated second data table to obtain a query result indicating at least one piece of the data from the first data table.

12. The data processing apparatus according to claim 11, wherein the obtaining code is configured to cause at least one of the at least one processor to:
obtain a plurality of key-value pairs comprising: a key-value pair indicating the first data table, a key-value pair indicating the second data table, and a key-value pair indicating the association relationship between the first data table and the second data table; and
create a virtual table based on the plurality of key-value pairs, and using the virtual table as the metadata.

13. The data processing apparatus according to claim 11, wherein the obtaining code is configured to cause at least one of the at least one processor to:
display a data configuration interface for the heterogeneous database comprising at least one configuration item from among: a first configuration item for configuring the first data table, a second configuration item for configuring the second data table, and a third configuration item for configuring the association relationship;
display, in response to receiving an instruction for configuring the at least one configuration item, configuration information of the at least one configuration item;
perform, in response to receiving an instruction for ending configuration, format conversion on the configuration information based on a data format for a corresponding key-value pair; and
generate the plurality of key-value pairs based on the configuration with the applied format conversion.

14. The data processing apparatus according to claim 12, wherein the program code further comprises authentication code configured to cause at least one of the at least one processor to:
invoke a permission service to perform authentication processing to determine whether a target object has permission to create the virtual table;
receive an authentication result from the permission service; and
trigger, based on the authentication result indicating that the target object has permission to create the virtual table, creation of the virtual table using the plurality of key-value pairs.

15. The data processing apparatus according to claim 11, wherein the association relationship comprises at least one of a cold-and-hot relationship, a union relationship, a primary-and-secondary relationship, and a materialized-view relationship, wherein
the cold-and-hot relationship indicates that the first data table stores full data in the first database, and the second data table stores partial data from the first data table;
the union relationship indicates that the first data table and the second data table unite to form full data in the first database;
the primary-and-secondary relationship indicates that the first data table stores full data in the first database, and the second data table stores backup data for the first data table; and
the materialized-view relationship indicates that the second data table stores result data obtained from pre-calculations performed on the first data table.

16. The data processing apparatus according to claim 15, wherein the association relationship comprises the cold-and-hot relationship, and wherein the updating code is configured to cause at least one of the at least one processor to:
obtain based on the cold-and-hot relationship mapped by the metadata, a data heating rule corresponding to the first data table; and
heat at least one piece of data from the first data table according to the data heating rule, and store, in the second data table, in the cross-source operation, the heated at least one piece of data from the first data table.

17. The data processing apparatus according to claim 16, wherein the data from the first data table is partitioned such that partitions of the first data table correspond to different time points, and an interval between adjacent partitions corresponds to a duration of one time unit, and
wherein the data heating rule indicates that:
data stored later than a target time point is eligible for heating, and
data in one or more partitions corresponding to one or more historical time points closest to a current time point is periodically heated at a preset heating frequency.

18. The data processing apparatus according to claim 17, wherein the updating code is configured to cause at least one of the at least one processor to:
screen one or more to-be-heated partitions from the first data table based on the data heating rule, wherein time points corresponding to the one or more to-be-heated partitions are later than the target time point;
if at least one of the one or more to-be-heated partitions is screened out:
if a number of the at least one screened out partition is less than or equal to a number of the one or more historical time points, heat data in the at least one screened out partition; and
if the number of the at least one screened out partition is greater than the number of the one or more historical time points, select from among the at least one screened out partition, a number of partitions equal to the number of the one or more historical time points, the selected at least one screened out partition corresponding to most recent historical time points; and
heat data in the at least one screened out partition; and
if no to-be-heated partition is screened out, determine that data heating has failed.

19. The data processing apparatus according to claim 16, wherein the metadata comprises a hot partition range that includes a time point corresponding to data stored in the second data table in the cross-source operation, and
wherein the updating code is configured to cause at least one of the at least one processor to:
obtain a plurality of time points corresponding to a plurality of pieces of data in the updated second data table, and determine a time range comprising the plurality of time points; and
update the hot partition range based on the determined time range.

20. A non-transitory computer storage medium, storing computer code which, when executed by at least one processor, causes the at least one processor to at least:
obtain metadata for a heterogeneous database comprising a first database and a second database, wherein the metadata maps an association relationship between a first data table of the first database and a second data table of the second database;
update the second data table by storing, in a cross-source operation, data from the first data table in the second data table based on the association relationship;
receive a query statement indicating the first data table; and
execute the query statement on the updated second data table to obtain a query result indicating at least one piece of the data from the first data table.
